(19) United States
(12) Patent Application Publication
(10) Pub. No.: US 2013/0173864 A1
(43) Pub. Date: Jul. 4, 2013

(54) SEMICONDUCTOR DEVICE INCLUDING ROW CACHE REGISTER

(71) Applicant: Elpida Memory, Inc., Tokyo (JP)

(72) Inventor: Kazuhiko KAJIGAYA, Tokyo (JP)

(73) Assignee: Elpida Memory, Inc., Tokyo (JP)

(21) Appl. No.: 13/733,767

(22) Filed: Jan. 3, 2013

(30) Foreign Application Priority Data
Jan. 4, 2012 (JP) 2012-000125
Jan. 11, 2012 (JP) 2012-002983

(51) Int. Cl. G06F 12/08

(52) U.S. Cl. CPC G06F 12/0891
USPC 711/144

(57) ABSTRACT

Disclosed herein is a device that includes a memory cell array having a plurality of pages, a row cache register, and an array control circuit. The array control circuit is configured to: select one of the pages as a selected page to form an electrical path between the selected page and the row cache register in response to a first command with a row address; cut the electrical path between the selected page and the row cache register; and form the electrical path again between the selected page and the row cache register in response to a second command without the row address.

### BACKGROUND OF THE INVENTION

1. Field of the Invention

The present invention relates to a semiconductor device, and more particularly to a semiconductor device that includes a row cache register.

2. Description of Related Art

A dynamic random access memory (DRAM), a typical semiconductor device, needs regular refresh operations to retain data in the form of charges stored in cell capacitors. A refresh operation is a similar operation to a so-called row access, and is thus not able to be performed when a page of a memory cell array is opened. To perform a refresh operation, the memory cell array needs to be once precharged to close the page. When the page of the memory cell array is closed, the data read into the sense amplifiers is discarded. Therefore, for the next column access, a row access needs to be performed again to open a page.

A technology for enabling a column access even when the memory cell array is in a precharged state has been known (for example, see Japanese Patent Application Laid-Open No. H03-212891, Japanese Patent Application Laid-Open No. H06-131867, Japanese Patent Application Laid-Open No. H09-306170, Japanese Patent Application. Laid-Open No. S62-214586 and Japanese Patent Application Laid-Open No. H01-138685). According to such a technology, registers called row cache registers are arranged between sense amplifiers in the memory cell array and an I/O line. Typically, a column access is performed by connecting a sense amplifier in the memory cell array to the I/O line. However, with this technology, a column access is performed by connecting a row cache register to the I/O line.

According to the technique, to allow a column access to the row cache registers, after a page is opened by issuing an act command and a row address, the sense amplifiers are connected to the row cache registers temporarily. As a result, data in a plurality of memory cells (page) corresponding to the issued row address is copied into the row cache registers, and the row cache registers become capable of a column access. After the copying, the row cache registers are disconnected from the sense amplifiers. Since the page can be closed by a precharge operation with the data retained in the row cache registers, the page need not be opened again even if a refresh operation is inserted between consecutive column accesses.

When a write operation is performed on a row cache register, the data in the page becomes inconsistent with the data in the row cache registers. Such inconsistency is resolved by a write back. More specifically, after the end of a column access, a write back command is issued with the same row address as the previously issued one. The semiconductor device opens the same page as the previous one again according to the write back command. As a result, the data in the row cache registers is written back to the corresponding page to resolve the inconsistency.

### SUMMARY

In one embodiment, there is provided a semiconductor device that includes: a memory cell array including a plurality of pages; a row cache register; and an array control circuit, when a row address is supplied, opening one of the pages selected based on the row address and temporarily connecting the selected page to the row cache register. The array control circuit, when a write command is issued after the selected page is closed, opens the selected page and connects the selected page to the row cache register.

In another embodiment, there is provided a semiconductor device that includes: a memory cell array including a plurality of pages; a row cache register; and an array control circuit including a page address storage circuit that stores a row address supplied last time thereto, the array control circuit opening one of the pages selected based on the row address stored in the page address storage circuit and connecting the selected page to the row cache register in response to write command when none of the pages is opened.

In still another embodiment, there is provided a semiconductor device that includes: an I/O line; a plurality of data lines including a first redundant data line and a first defective data line; a plurality of column switches each connected between an associated one of the data lines and the I/O line; a plurality of row cache registers each connected to an associated one of the data lines; a plurality of memory blocks each including a bit line and a plurality of word lines, one of the memory blocks being selected based on a block address which is a part of a row address; a plurality of transfer switches each connected between an associated one of the bit lines and an associated one of the data lines; and an array control circuit activating one of the word lines based on the row address and temporarily bringing one of the transfer switches related to the activated word line into an ON state. The array control circuit includes: a first defective address information storage circuit storing first address information indicating a combination of a column address related to the first defective data line and the block address of one of the memory blocks related to the first defective data line; and a row address storage circuit storing at least the block address included in the row address supplied from outside. The array control circuit obtains second address information in response to a write command, the second address information indicating a combination of a column address supplied from outside along with the write command and the block address stored in the row address storage circuit. The array control circuit brings one of the column switches based on the column address supplied from outside into an ON state when the second address information does not coincide with the first address information stored in the first defective address information storage circuit. The array control circuit brings one of the column switches corresponding to the first redundant data line into an ON state when the second address information coincides with the first address information stored in the first defective address information storage circuit. The array control circuit activates one of the word lines based on the row address and brings one of the transfer switches related to the activated word line into an ON state in response to the write command.

In still another embodiment, there is provided a semiconductor device that includes: an I/O line; a plurality of first data lines including a first redundant data line and a first defective data line; a plurality of second data lines each provided for an associated one of the first data lines, the second data lines including a second redundant data line corresponding to the first redundant data line; a plurality of first column switches connected between an associated one of the first data lines and the I/O line; a plurality of second column switches connected between an associated one of the second data lines and the I/O line; a plurality of first row cache registers each provided for an associated one of the respective first data lines; a plurality of second row cache registers each provided for an associated one of the second data lines; a plurality of memory blocks each including a bit line and a plurality of word lines, one of the memory blocks being selected based on a block address which is a part of a row address; a plurality of first transfer switches each connected between the bit line included in an associated one of the memory blocks and an associated one of the first transfer switches; and a plurality of second transfer switches each connected between the bit line included in an associated one of the memory blocks and an associated one of the second transfer switches; and an array control circuit activating a first word line included in the plurality of word lines based on the row address supplied from outside along with a first active command and temporarily bringing one of the first transfer switches related to the first word line into an ON state, the array control circuit activating a second word line included in the plurality of word lines based on the row address supplied from outside along with a second active command and temporarily bringing one of the second transfer switches related to the second word line into an ON state. The array control circuit includes: a defective address information storage circuit storing first address information indicating a combination of a column address related to the first defective data line and the block address of one of the memory blocks related to the first defective data line; a first row address storage circuit storing at least the block address included in the row address supplied along with the first active command; and a second row address storage circuit storing at least the block address included in the row address supplied along with the second active command. The array control circuit obtains second address information in response to a first write command, the second address information indicating a combination of a column address supplied from outside along with the first write command and the block address stored in the first row address storage circuit. The array control circuit brings one of the first column switches based on the column address supplied along with the first write command into an ON state when the second address information does not coincide with the first address information stored in the defective address information storage circuit. The array control circuit brings one of the first column switches corresponding to the first redundant data line into an ON state when the second address information coincides with the first address information stored in the defective address information storage circuit. The array control circuit activates the first word line again and brings one of the first transfer switches into an ON state again in response to the first write command. The array control circuit obtains third address information in response to a second write command, the third address information indicating a combination of a column address supplied from outside along with the second write command and the block address stored in the second row address storage circuit. The array control circuit brings one of the second column switches based on the column address supplied along with the second write command into an ON state when the third address information does not coincide with the first address information stored in the defective address information storage circuit. The array control circuit brings one of the second column switches corresponding to the second redundant data line into an ON state when the third address information coincides with the first address information stored in the defective address information storage circuit. The array control circuit activates the second word line again and brings one of the second transfer switches into an ON state again in response to the second write command.

### BRIEF DESCRIPTION OF THE DRAWINGS

FIG. 1 is a diagram indicative of a semiconductor device according to a first embodiment of the present invention;

FIG. 2 is a diagram showing characteristic parts extracted from the components of the semiconductor device shown in FIG. 1;

FIG. 3 is a diagram schematically showing the internal structure of the memory block shown in FIG. 2;

FIG. 4 is a diagram showing connections between the bit line pairs BLP, data line pairs DLP, and I/O line pair IOLP with respect to a single data line pair DLP;

FIG. 5 is a diagram showing connections between the data line pairs DIP and the I/O line pair IOLP with respect to the single I/O line pair IOLP;

FIG. 6A is a waveform chart showing temporal changes of relevant signals when a write command WRT is issued;

FIG. 6B is a waveform chart showing temporal changes of relevant signals when a write command WRT is issued and the page has already been opened by the point in time;

FIG. 7 is a waveform chart showing temporal changes of relevant signals when a write with auto precharge command WAP is issued;

FIG. 8 is a process flowchart of the array control circuit 36 when an act command ACT is issued;

FIG. 9 is a process flowchart of the array control circuit 36 when a precharge command PRE is issued subsequent to step S9;

FIG. 10 is a process flowchart of the array control circuit 36 when a write command WRT is issued;

FIG. 11 is a process flowchart showing the write processing shown in FIG. 10 in detail;

FIG. 12 is a process flowchart of the array control circuit 36 when a write with auto precharge command WAP is issued;

FIG. 13 is a process flowchart of the semiconductor device 10 when a read command RED is issued;

FIG. 14 is a process flowchart of the array control circuit 36 when an auto refresh command REF is issued;

FIG. 15 is a process flowchart of the array control circuit 36 when an auto refresh command REF is issued according to a modification;

FIG. 16 is a process flowchart of the array control circuit 36 when another act command ACT is issued after the series of processes shown in FIGS. 8 and 9;

FIG. 17 is a timing chart of various signals when a write command WRT is issued;

FIG. 18 is a timing chart of various signals when a write with auto precharge command WAP is issued;

FIG. 19 is a diagram indicative of a semiconductor device according to a second embodiment of the present invention;

FIG. 20 is a diagram showing characteristic parts extracted from the components of the semiconductor device shown in FIG. 19;

FIG. 21 is a diagram showing connections between the data line pairs DLP and the I/O line pair IOLP with respect to the single I/O line pair IOLP;

FIG. 22A is a diagram showing the circuit configuration of the row address generation circuit 56ₙ (n=i, j, . . . , 0) shown in FIG. 20;

FIG. 22B is a diagram showing the circuit configuration of the row address storage circuits 57ᵢ and 57ⱼ shown in FIG. 20;

FIG. 23 is a diagram showing the circuit configuration of the address comparison circuits 52A to 52D and the defective address information storage circuits 53A to 53D shown in FIG. 20;

FIG. 24 is a timing chart of various signals related to the semiconductor device shown in FIG. 20;

FIG. 25 is a diagram indicative of a semiconductor device according to a third embodiment of the present invention;

FIG. 26 is a diagram showing connections between the bit line pairs BLP, data line pairs DLP₀ and DLP₁, and I/O line pair IOLP with respect to each of the data line pairs DLP₀ and DLP₁;

FIG. 27A is a diagram showing the circuit configuration of the row address storage circuits 57₀ᵢ and 57₀ⱼ shown in FIG. 26;

FIG. 27B is a diagram showing the circuit configuration of the row address storage circuits 57₁ᵢ and 57₁ⱼ shown in FIG. 26;

FIG. 28 is a diagram showing the circuit configuration of the address comparison circuits 52A₀ to 52D₀ and 52A₁ to 52D₁ and the defective address information storage circuits 53A to 53D;

FIG. 29 is a timing chart of various signals related to the semiconductor device shown in FIG. 26;

FIG. 30 is a diagram indicative of a semiconductor device according to a fourth embodiment of the present invention;

FIG. 31 is a diagram showing connections between bit line pairs BLP, data line pairs DLP, and an I/O line pair IOLP with respect to a single data line pair DLP;

FIG. 32 is a timing chart of various signals related to the semiconductor device shown in FIG. 31;

FIG. 33 is a diagram indicative of a semiconductor device according to a fifth embodiment of the present invention;

FIG. 34A is a diagram showing the circuit configuration of the row address generation circuit 56ₙ (n=i, j, . . . , 0) shown in FIG. 33;

FIG. 34B is a diagram showing the circuit configuration of the row address storage circuit 57ₙ (n=i, j, . . . , 0) shown in FIG. 33;

FIG. 35 is a timing chart of various signals related to the semiconductor device shown in FIG. 33;

FIG. 36 is a diagram indicative of a semiconductor device according to a sixth embodiment of the present invention;

FIG. 37 is a timing chart of various signals related to the semiconductor device shown in FIG. 36; and

FIG. 38 is a diagram indicative of an embodiment of a computer 70.

### DETAILED DESCRIPTION OF THE EMBODIMENTS

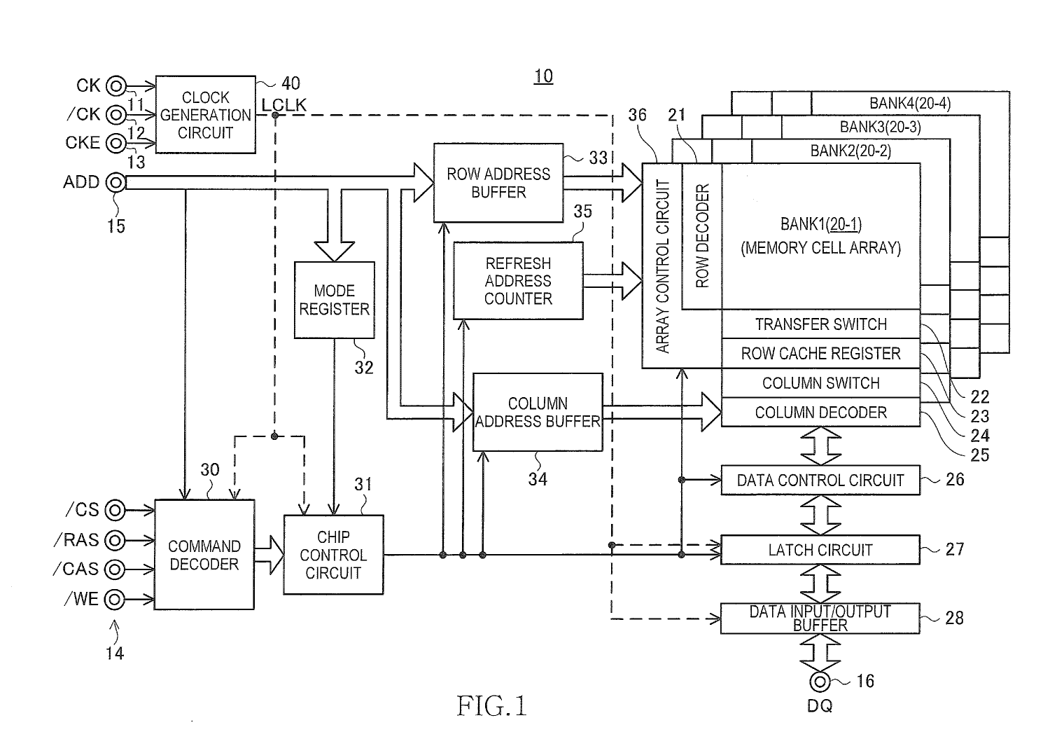

Referring now to FIG. 1, the semiconductor device 10 according to the first embodiment of the present invention includes clock terminals 11 and 12, a clock enable terminal 13, command terminals 14, an address terminal 15, and a data input/output terminal 16 as input/output terminals for transmitting and receiving signals to/from outside. The semiconductor device 10 includes four banks 20-1 to 20-4 (banks 1 to 4), and includes a row decoder 21, a transfer switch 22, a row cache register 23, a column switch 24, a column decoder 25, and an array control circuit 36 for each bank. The semiconductor device 10 further includes a data control circuit 26, a latch circuit 27, a data input/output buffer 28, a command decoder 30, a chip control circuit 31, a mode register 32, a row address buffer 33, a column address buffer 34, and a refresh address counter 35.

The clock terminals 11 and 12 are supplied with an external clock signal CK and its inverted signal /CK, respectively. The clock enable terminal 13 is supplied with a clock enable signal CKE. As employed herein, the leading symbol “/” of a signal name indicates that the signal is either an inverted signal of the corresponding signal or a low-active signal. The external clock signals CK and /CK are, therefore, signals complementary to each other. A clock generation circuit 40 generates an internal clock signal LCLK based on the external clock signals CK and /CK. The generated internal clock signal LCLK is supplied to various components in the semiconductor device 10.

The command terminals 14 include a plurality of terminals to which a chip select signal /CS, a row address strobe signal /RAS, a column address strobe signal /CAS, and a write enable signal /WE are supplied, respectively. By combining the logic levels of such command signals, an external controller supplies various commands to the semiconductor device 10. Examples of the commands include an act command ACT, a write command WRT, a read command RED, an auto refresh command REF, and a precharge command PRE. The command signals are supplied to the chip control circuit 31 through the command decoder 30 which retains, decodes, counts, and otherwise processes the command signals. The chip control circuit 31 generates various internal commands based on the output of the command decoder 30. The chip control circuit 31 thereby controls the operation of the data control circuit 26, the latch circuit 27, the array control circuits 36 of the respective banks, the row address buffer 33, the column address buffer 34, and the refresh address counter 35. The command decoder 30 and the chip control circuit 31 perform processing in synchronism with the internal clock signal LCLK.

The address terminal 15 is supplied with address signals A0 to Ai, BA0, and BA1. The address signals A0 to Ai, BA0, and BA1 are input to the semiconductor device 10 in synchronism with command signals. The address signals BA0 and BA1 indicate a bank address that designates the bank to be subjected to an operation such as read and write. The address signals BA0 and BA1 are supplied to both the row address buffer 33 and the column address buffer 34. The address signals A0 to Ai, when input in synchronism with an act command ACT, indicate a row address XA to be described later and are supplied to the row address buffer 33. When input in synchronism with a write command WRT or read command RED, the address signals A0 to Ai indicate a column address YA and are supplied to the column address buffer 34. If the semiconductor device 10 is in a mode register set mode, the address signals A0 to Ai provide information indicating the mode of the semiconductor device 10, and are supplied to the mode register 32. The address signals buffered in the row address buffer 33 are supplied to the array control circuits 36. The address signals buffered in the column address buffer 34 are supplied to the column decoders 25. The processing of the array control circuits 36 and the column decoders 25 will be described later.

The data input/output terminal 16 is a terminal for inputting and outputting read data DQ or write data DQ. The semiconductor device 10 includes a plurality of data input/output terminals 16. The plurality of input/output terminals 16 are each connected to the data control circuit 26 through the data input/output buffer 28 and the latch circuit 27. The data input/output buffer 28 includes a not-shown input buffer and output buffer. Using such buffers, the data input/output buffer 28 inputs and outputs the read data DQ or write data DQ in synchronism with the internal clock signal LCLK. The latch circuit 27 is a circuit for implementing a so-called double data rate (DDR) function. The latch circuit 27 includes first-in first-output (FIFO) circuits and multiplexer circuits. The FIFO circuits input and output data in synchronism with the internal clock signal LCLK. The data control circuit 26 includes data amplifier circuits and multiplexer circuits. By such circuits, parallel read data supplied from the column switches 24 is converted from a differential form into a single end form and then converted into serial read data, which is output from a data input/output terminal 16 to outside. Serial write data supplied from a data input/output terminal 16 is converted into parallel write data and is converted from a single end form into a differential form, and then supplied to the column switches 24. The chip select circuit 31 switches the multiplexer circuits in the latch circuit 27 and the multiplexer circuits in the data control circuit 26.

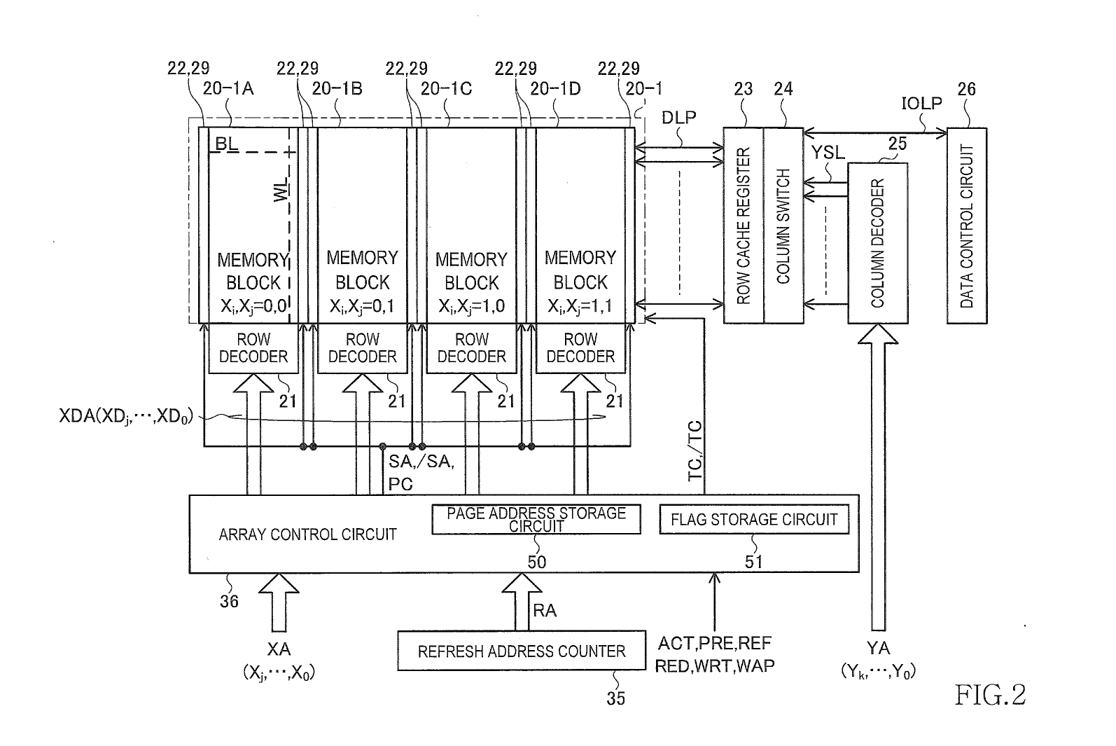

Turning to FIG. 2, while the diagram shows a configuration pertaining to the bank 20-1, the other banks have a similar configuration. The configuration of the semiconductor device 10 will be described in more detail below with reference to FIG. 2.

Initially, the internal configuration of the bank 20-1 and a peripheral configuration of the same will be described. As shown in FIG. 2, the bank 20-1 is divided into four memory blocks 20-1A to 20-1D. Such memory blocks are specified by two bits (block address) of the row address XA (Xⱼ, . . . , X₀).

The memory blocks 20-1A to 20-1D and the column switch 24 are connected by a plurality of data line pairs DLP. The data line pairs DLP are connected to row cache registers 23 provided for the respective data line pairs DLP. The column switch 24 and the data control circuit 26 are connected by a single I/O line pair IOLP (equivalent to a pair of I/O lines; the same applies below). It will be understood that the column switch 24 and the data control circuit 26 may be connected by a plurality of I/O line pairs IOLP. In fact, there are provided a plurality of I/O line pairs IOLP. The memory blocks 20-1A to 20-1D each include a plurality of bit line pairs BLP provided for the respective data pairs DLP, and a plurality of word lines WL.

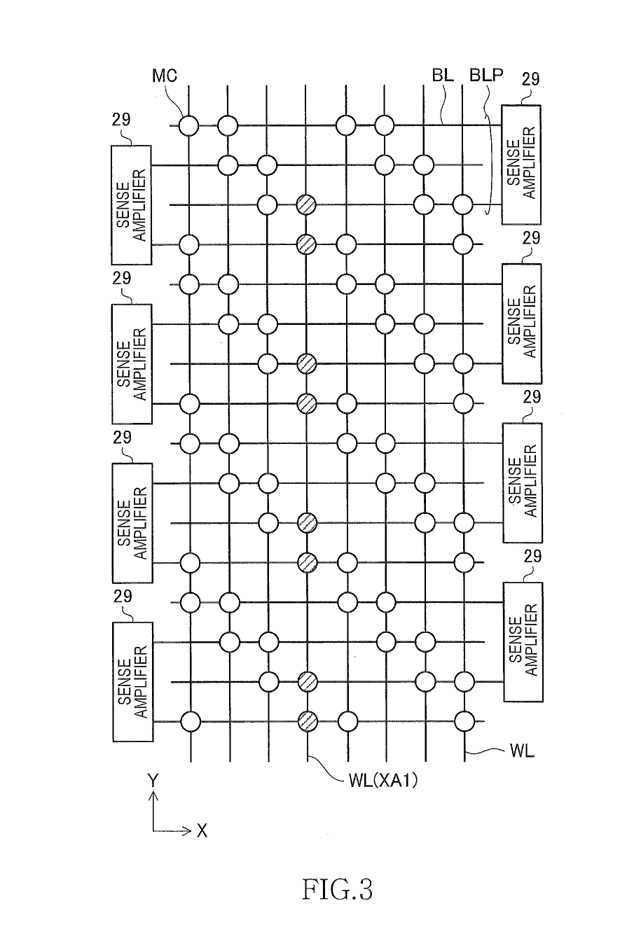

As shown in FIG. 3, the memory block 20-1A includes a plurality of bit lines BL which are at regular intervals and each extend in the X direction, and a plurality of word lines WL which are at regular intervals and each extend in the Y direction (direction orthogonal to the X direction within the plane). Memory cells MC are arranged at intersections of the bit lines BL and the word lines BL. Although not shown, the other memory blocks have a similar internal structure.

The semiconductor device 10 according to the present embodiment employs the configuration of using a bit line pair BLP including two complementary bit lines BL as a bit line. As shown in FIG. 3, the memory cells MC of the semiconductor device 10 are arranged at a rate of one for each intersection of a bit line pair BLP and a word line WL. In the present embodiment, such a bit line pair may be referred to simply as a bit line. Since the bit lines of the semiconductor device 10 are composed of bit line pairs BLP, the data lines and I/O lines are also composed of data line pairs DLP and I/O line pairs IOLP, respectively. In the present Specification, such line pairs may be referred to simply as data lines and I/O lines. Note that the bit lines, data lines, and I/O lines may be formed in a single end configuration instead of the complementary form as described in the present embodiment.

As shown in FIG. 3, sense amplifiers 29 for respective bit line pairs BLP are arranged at the ends of the bit line pairs BLP. Due to limitations of installation space, the sense amplifiers 29 are alternately disposed to one end and the other end of the bit line pairs BLP in the X direction as viewed in order from one end of the Y direction.

Returning to FIG. 2, the bit line pairs BLP are each connected to a data line pair DLP through a transfer switch 22. The data line pairs DLP are each connected to the I/O line pair IOLP through the column switch 24.

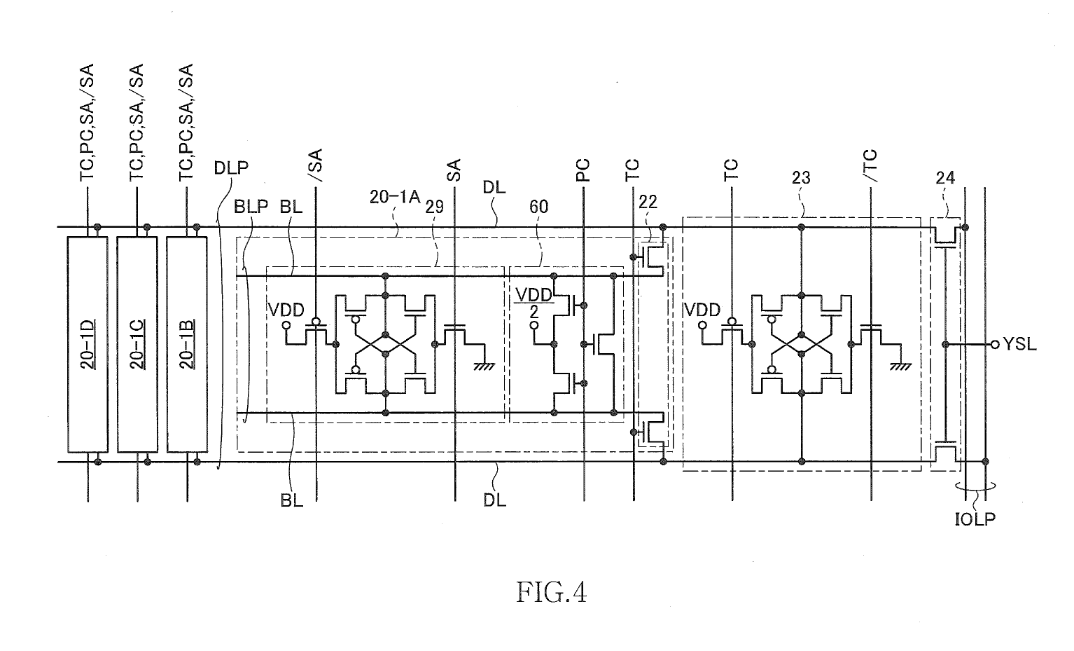

As shown in FIG. 4, a data line pair DLP is connected to a bit line pair BLP in the memory block 20-1A through the transfer switch 22 in the memory block 20-1A. The transfer switch 22 includes two transistors. One of the transistors is connected between either one of data lines DL constituting the data line pair DLP and either one of bit lines BL constituting the bit line pair BLP. The other transistor is connected between the other bit line BL constituting the data line pair DLP and the other bit line BL constituting the bit line pair BLP. Although not shown in detail in the diagram, the memory blocks 20-1B to 20-1D include similar transfer switches 22. Through such transfer switches 22, the data line pair DLP is also connected to the bit line pairs BLP arranged in the respective memory blocks 20-1B to 20-1D. A transfer signal TC is input to the control electrodes of the respective transistors constituting the transfer switches 22. The connection state of the transfer switches 22 is thus controlled by the transfer switch TC so that only one of the bit line pairs BLP of the memory blocks 20-1A to 20-1D is connected to the data line pair DLP. Two or more bit line pairs BLP therefore will not be connected to the same data line pair DLP at the same time.

The data line pair DLP is connected to the I/O line pair IOLP through the column switch 24. The column switch 24 includes two transistors. One of the transistors is connected between either one of the data lines DL constituting the data line pair DLP and either one of I/O lines IOL constituting the I/O line pair IOLP. The other transistor is connected between the other data line DL constituting the data line pair DLP and the other I/O line IOL constituting the I/O line pair IOLP. The control electrodes of the transistors constituting the column switch 24 are connected to a column switch line YSL. The connection state of the column switch 24 is thus controlled by the potential of the column switch line YSL.

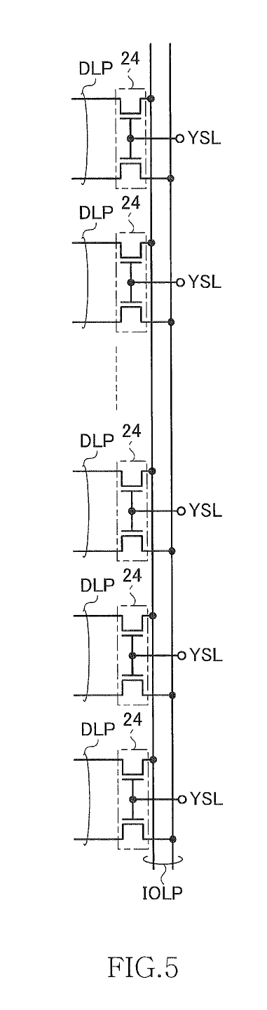

As shown in FIG. 5, a plurality of data line pairs DLP are connected to a single I/O line pair IOLP. Between the respective data line pairs DLP and the I/O line pair IOLP, column switches 24 are arranged as described above. The connection states of the column switches 24 are controlled by the processing of the column decoder 25 to be described later so that only one of the data line pairs DLP is connected to the I/O line pair IOLP. Two or more data line pairs DLP therefore will not be connected to the same I/O line pair IOLP at the same time.

Returning to FIG. 4, FIG. 4 also shows a detailed configuration of the row cache register 23 and the sense amplifier 29. As shown in FIG. 4, a precharge circuit 60 is connected between the two bit lines BL constituting the bit line pair BLP. The configuration of such circuits is described below.

The row cache register 23 is a latch circuit including two CMOS inverters which are cyclically connected. The input terminal of one of the CMOS inverters is connected to the output terminal of the other CMOS inverter and the other data line DL constituting the data line pair DLP. The input terminal of the other CMOS inverter is connected to the output terminal of the one CMOS inverter and the one data line DL constituting the data line pair DLP. A power supply voltage VDD is supplied to either one of power supply nodes of the two CMOS inverters through a P-channel MOS transistor. The other power supply node is grounded through an N-channel MOS transistor. An inverted signal /TC of the transfer signal TC is supplied to the control electrode of the N-channel MOS transistor. The transfer signal TC is supplied to the control electrode of the P-channel MOS transistor. Having such a structure, the row cache register 23 functions to latch the data on the data line pair DLP when the transfer signal TC is inactive. Although not shown in the diagram, the transfer signal TC and the inverted signal /TC of the transfer signal TC supplied to the row cache register 23 are generated by ORing four transfer signals TC supplied to the memory blocks 20-1A to 20-1D.

With such a configuration employed, the power supply node of the row cache register 23 is disconnected from the power supply wiring when the transfer signal TC is activated. The semiconductor device 10 can thus easily invert the data of the row cache register 23 by using the sense amplifier 29.

The sense amplifier 29 is also a latch circuit including two CMOS inverters which are cyclically connected. The input terminal of one of the CMOS inverters is connected to the output terminal of the other CMOS inverter and the other bit line BL constituting the bit line pair BLP. The input terminal of the other CMOS inverter is connected to the output terminal of the one CMOS inverter and the one bit line BL constituting the bit line pair BLP. The power supply voltage VDD is supplied to one of the power supply nodes of the two CMOS inverters through a P-channel MOS transistor. The other power supply node is grounded through an N-channel MOS transistor. A sense amplifier signal SA is supplied to the control electrode of the N-channel MOS transistor. An inverted signal /SA of the sense amplifier signal SA is supplied to the control electrode of the P-channel MOS transistor. Having such a structure, the sense amplifier 29 functions to amplify a small potential difference occurring between the two bit lines BL constituting the bit line pair BLP to VDD when the sense amplifier signal SA is activated.

The precharge circuit 60 includes two N-channel MOS transistors connected in series between the two bit lines BL constituting the bit line pair BLP, and an N-channel MOS transistor connected between the two bit lines BL constituting the bit line pair BLP. A precharge signal PC is supplied to the control electrodes of the N-channel MOS transistors in common. A voltage VDD/2, which is ½ the power supply voltage VDD, is supplied to the node between the two N-channel MOS transistors connected in series. When the precharge signal PC is activated, both the bit lines BL constituting the bit line pair BLP are thus precharged to the voltage VDD/2.

Returning to FIG. 2, the column decoder 25 has the function of receiving the column address YA (Yₖ, . . . , Y₀) supplied from the column address buffer 34, and activating a column switch line YSL corresponding to the column address YA. As a result, the column switch 24 corresponding to the supplied column address YA enters a connected state, whereby the corresponding data line pair DLP is connected to the I/O line pair IOLP.

The array control circuit 36 has the following functions. One is, when an act command ACT is input from outside, to open a page corresponding to a row address XA input in synchronization with the act command ACT. Another is to close the page when a precharge command PRE is input from outside. The other is, when an auto refresh command REF is input from outside, to refresh a page corresponding to a refresh address RA generated by the refresh address counter 35. Each of the functions will be described in detail below.

When an act command ACT is input from outside, the array control circuit 36 initially controls the precharge signal PC to a low level. This stops the supply of the voltage VDD/2 (FIG. 4) to the bit line pairs BLP. Next, the array control circuit 36 generates and supplies a row address XDA (XDⱼ, . . . , XD₀) to the row decoders 21, thereby activating the word line WL designated by the row address XDA. The row address XDA (XDⱼ, . . . , XD₀) here is the same as the row address XA (Xⱼ, . . . , X₀) supplied from the row address buffer 33. The array control circuit 36 then activates the sense amplifier signal SA to activate the sense amplifiers 29. The processing so far opens the page corresponding to the row address XA. Next, the array control circuit 36 activates the transfer signal TC to turn the transfer switches 22 on (connected state). The data in the page corresponding to the row address XDA is thereby supplied to the row cache registers 23 through the bit line pairs BLP and the data line pairs DLP. Subsequently, the array control circuit 36 deactivates the transfer signal TC to turn the transfer switches 22 off (disconnected state). As a result, the corresponding page is disconnected from the row cache registers 23 and is copied into the row cache registers 23.

When a precharge command PRE is input from outside, the array control circuit 36 initially deactivates the word line WL. The array control circuit 36 then deactivates the sense amplifier signal SA to deactivate the sense amplifiers 29, and further controls the precharge signal PC to a high level. The page that has so far been opened is closed by such processing.

When an auto refresh command REF is input from outside, the array control circuit 36 initially opens a page like when an act command ACT is input. Specifically, the array control circuit 36 controls the precharge circuit PC to a low level. This stops the supply of the voltage VDD/2 (FIG. 4) to the bit line pairs BLP. The array control circuit 36 then generates and supplies a row address XDA (XDⱼ, . . . , XD₀) to the row decoders 21, thereby activating the word line WL designated by the row address XDA. The row address XDA (XDⱼ, . . . , XD₀) here is the same as the refresh address RA supplied from the refresh address counter 35. The refresh address RA is address information indicating the row address to be refreshed, and is generated by the refresh address counter 35. The refresh address counter 35 is a circuit that generates a refresh address RA under the control of the chip control circuit 31 to which the auto refresh command REF is input. The refresh address counter 35 includes a not-shown increment circuit, and generates refresh addresses RA so that all the row addresses are sequentially subjected to refresh processing. Finally, the array control circuit 36 activates the sense amplifier signal SA to activate the sense amplifiers 29. As a result, each memory cell MC in the page designated by the refresh address RA is refreshed.

The array control circuit 36 typically performs a page open only when an act command ACT or an auto refresh command REF is input from outside as described above. However, in the present embodiment, the array control circuit 36 also performs a page open when a write command WRT (or write with auto precharge command WAP to be described later) is input from outside. Such an operation provides the effect of eliminating the need for a write back. The external controller is designed, if an act command ACT is followed by a write command WRT, to input a precharge command PRE when performing an auto refresh or a page close. Since the page is closed during the period before the write command WRT is input, an auto refresh can be performed in that period. A detailed description thereof will be given below.

As shown in FIG. 2, the array control circuit 36 includes a page address storage circuit 50 and a flag storage circuit 51. The page address storage circuit 50 is a circuit that stores the last row address XA input from outside. The flag storage circuit 51 is a circuit that stores a page close flag which indicates that a page is closed. The array control circuit 36 uses such storage circuits to implement the page open according to a write command WRT (or write with auto precharge command WAP to be described later).

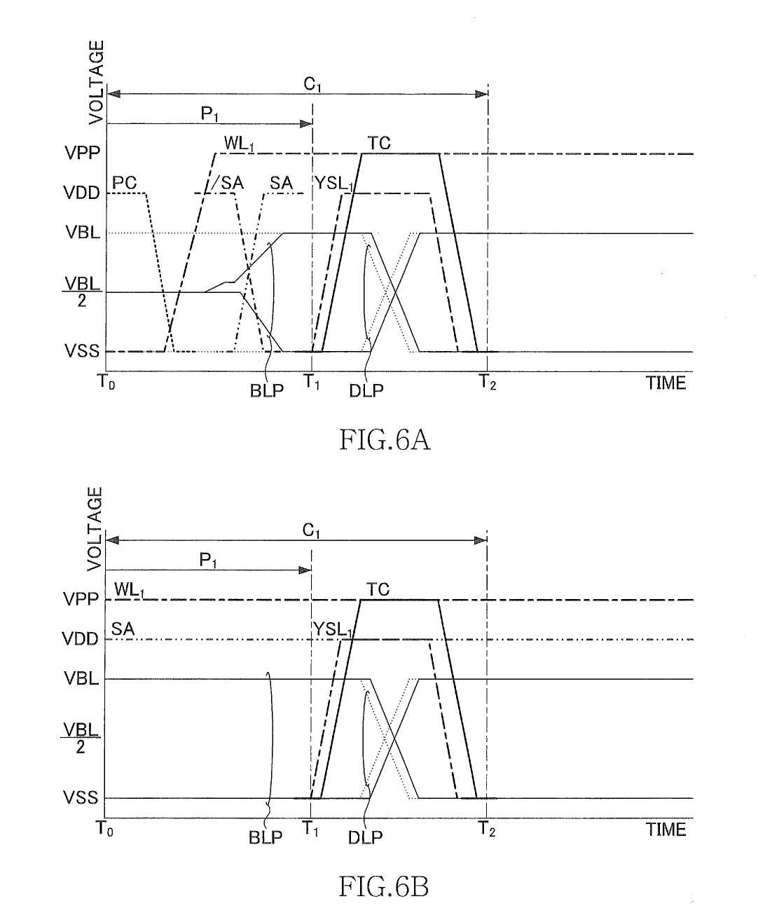

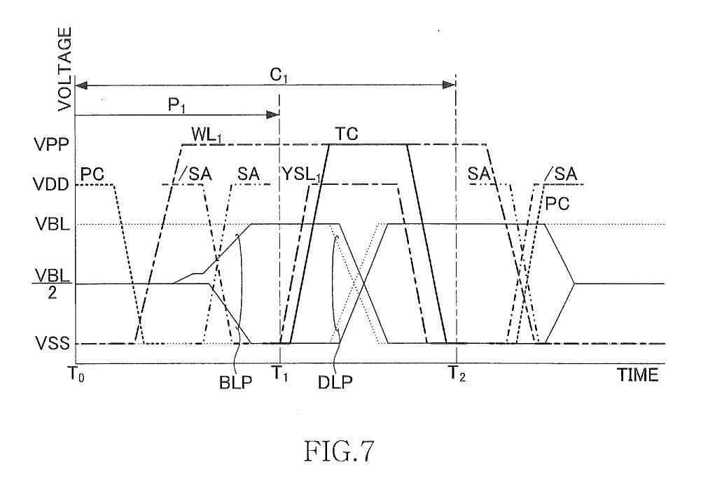

In the example of FIG. 6A, the page is assumed to be closed at the point in time when the write command WRT is input. In FIG. 6A and subsequent FIGS. 6B and 7, the word line WL corresponding to the page to be written is denoted as the word line WL₁. The column switch line YSL corresponding to the memory cell MC to be written is denoted as the column switch line YSL₁. The write command WRT is issued at time T₀. Write data arrives at the column switch 24 (FIG. 2) at time T₁ which is time P₁ past time T₀. A series of write operations is subsequently completed at time T₂. In other words, the period C₁ between times T₀ and T₂ corresponds to a write cycle.

At the time when the write command WRT is input (time T₀), the corresponding word line WL₁ is in a deactivated state. The sense amplifier signal SA is also inactive. The precharge signal PC is maintained to a high level. In other words, the page is closed. The array control circuit 36 refers to the page close flag stored in the flag storage circuit 51 and acquires that the page is closed.

If the page is closed, the array control circuit 36 initially performs processing for opening the page. Specifically, as shown in FIG. 6A, the array control circuit 36 initially controls the precharge signal PC to a low level, and then activates the word line WL₁. The row address XA stored in the page address storage circuit 50 is used as the row address XDA to be supplied to the row decoders 21 when activating the word line WL₁. More specifically, the page address storage circuit 50 contains the last input row access XA. At the time when the write command WRT is input, such a row address XA indicates the row address of the page to be written. The array control circuit 36 then reads the row address XA from the page address storage circuit 50, and supplies the row address XA to the row decoders 21 as a row address XDA.

Activating the word line WL₁, the array control circuit 36 then activates the sense amplifier signal SA and the inverted signal /SA of the sense amplifier signal SA. The processing so far is the same as when an act command ACT is input. The array control circuit 36 completes the series of processes by time T₁ when the write data arrives at the column switch 24.

Next, after time T₁ when the write data from the column decoder 25 arrives at the column switch 24, the column switch line YSL₁ and the transfer signal TC are activated sequentially. As a result, the corresponding column switch 24 and the corresponding transfer switch 22 enter connected states sequentially, whereby the corresponding bit line pair BLP, the corresponding data line pair DLP, and the I/O line pair IOLP are connected. After a while, the write data is reflected on the potentials of the data line pair DLP and the bit line pair BLP sequentially. The potentials of the bit line pair BLP overwrite the data of the sense amplifier 29 connected to the corresponding bit line pair BLP, and the write data is finally stored into the corresponding memory cell MC. After the writing to the memory cell MC, the column switch line YSL₁ and the transfer signal TC are successively deactivated.

As is clear from the configuration described in FIG. 4, the power supply to the row cache register 23 is shut down when the transfer switch 22 is activated. This is a configuration so as to prevent the potential of the write data from changing as a result of that the data latched in the row cache register 23 affects the potential of the data line pair DLP.

The processing when a write command WRT is input has been completed so far. After the completion of the write cycle (after time T₂), the page is thus maintained open. This can reduce the frequency of page close and page open operations when the same page (different memory cells MC thereof) continues to be written. Now, the processing corresponding to the second write command WRT in such a situation where write commands WRT are consecutively issued will be described referring to FIG. 6B.

In the case shown in FIG. 6B, at the time when the write command WRT is input (time T₀), the corresponding word WL₁ is activated. The sense amplifier signal SA is activated as well. Although not shown, the precharge signal PC is controlled to a low level. In other words, the page is already opened. The array control circuit 36 acquires that the page is already open by referring to the page close flag stored in the flag storage circuit 51.

If the page is already open, a processing to open a page like shown in FIG. 6A is not performed. Meanwhile, the processing after time T₁ is the same as in the example of FIG. 6A. More specifically, the activation of the column switch line YSL₁ by the column decoder 25 and the activation of the transfer signal TC are successively performed to store the write data into the corresponding memory cell MC. After the writing to the memory cell MC, the column switch line YSL₁ and the transfer signal TC are successively deactivated.

In the examples of FIGS. 6A and 6B, the page is maintained open after the completion of the write cycles (after time T₂). However, the page may be automatically closed. Such a configuration is implemented by inputting a write with auto precharge command WAP from outside. The write with auto precharge command WAP is a command for making the semiconductor device 10 autonomously perform a precharge operation after performing a write operation according to a write command WRT. A detailed description will be given below referring to FIG. 7.

As shown in FIG. 7, the operations up to time T₂ are the same as shown in FIG. 6A. After the lapse of time T₂, the array control circuit 36 successively deactivates the word line WL₁, the sense amplifier signal SA, and the precharge signal PC. This closes the page and makes it possible to accept an auto refresh command REF.

As described above, according to the semiconductor device 10 of the present embodiment, the array control circuit 36 performs a page open if the page is closed at the time when a write command WRT (or write with auto precharge command WAP) is input, as well as when an act command ACT or auto refresh command REF is input. Since the write data is written to the page to be written at the time of the write operation, a write back becomes unnecessary. This secures compatibility with semiconductor devices that employ no row cache register 23.

In addition, since the row address XA is stored in the page address storage circuit 50, a write operation can be performed on the page to be written without the need to input an act command and a row address for each write operation. The semiconductor device 10 according to the present embodiment thus maintains a memory access efficiency equivalent to that of conventional semiconductor devices that employ row cache registers.

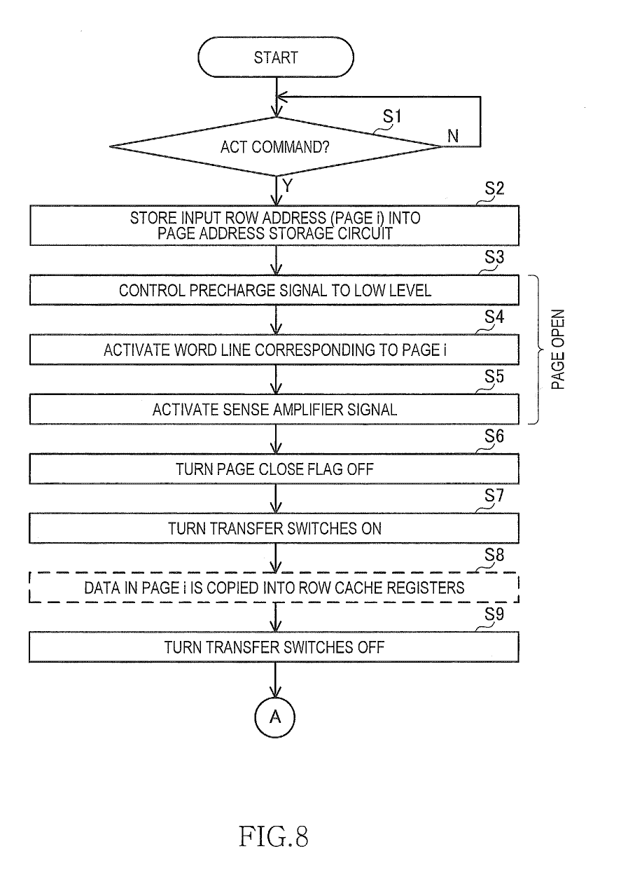

The processing of the array control circuit 36 when various commands are input will be described in more detail again from different viewpoints with reference to processing procedures of the array control circuit 36 referring to FIG. 8 to FIG. 16. In these figures, the steps shown in broken lines represent ones performed by circuits other than the array control circuit 36.

As shown in FIG. 8, the array control circuit 36 in an initial state waits for an act command ACT to be input (step S1). If an act command ACT is input, the array control circuit 36 stores a row address (assume it to be a row address designating a page i) input with the act command ACT into the page address storage circuit 50 (step S2). The array control circuit 36 then performs processing for opening the page i (steps S3 to S5). The details of the page open processing are as described above. After the page i is opened, the array control circuit 36 turns off (inactive state) the page close flag in the flag storage circuit 51 (step S6). The array control circuit 36 then activates the transfer signal TC to turn on (connected state) the transfer switches 22 (step S7). Through the foregoing processing, the data in the page i is copied into the row cache registers 23 (step S8). After step S8, the array control circuit 36 deactivates the transfer signal TC to turn off (disconnected state) the transfer switches 22 (step S9).

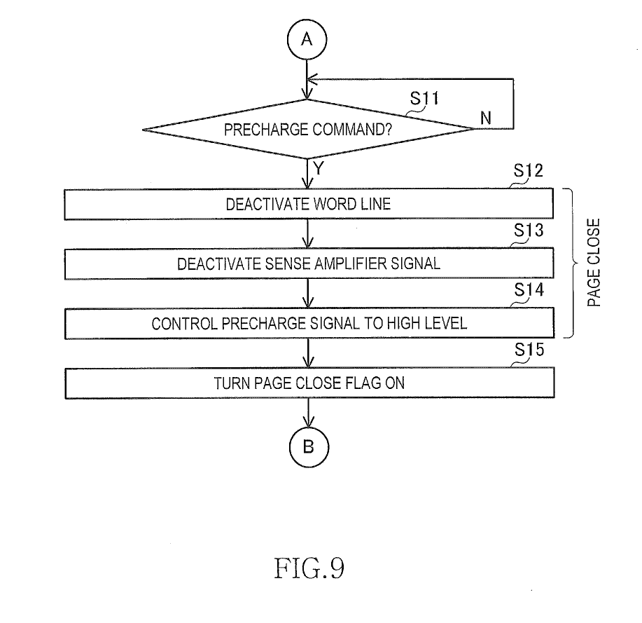

If a precharge command PRE is issued subsequent to step S9 as shown in FIG. 9 (step S11), the array control circuit 36 performs processing for closing the page i as shown in the flowchart (steps S12 to S14). The details of the page close processing are as described above. After the page i is closed, the array control circuit 36 turns on (active state) the page close flag in the flag storage circuit 51 (step S15).

As described above, the external controller is designed to input a precharge command PRE after an act command ACT. In the period between the input of the act command ACT and the input of the precharge command PRE (the period between steps S9 and S11), a read command RED or a write command WRT (or write with auto precharge command WAP) may be input. In this case, a read is performed on the row cache registers 23. A write is performed on the row cache registers 23 as well as the corresponding memory cells MC of the open page as described with reference to FIG. 6B. After step S15 (or the completion of a write with auto precharge command WAP), the page enters a closed state. The memory cells MC can thus be refreshed in parallel with column accesses to the row cache registers 23.

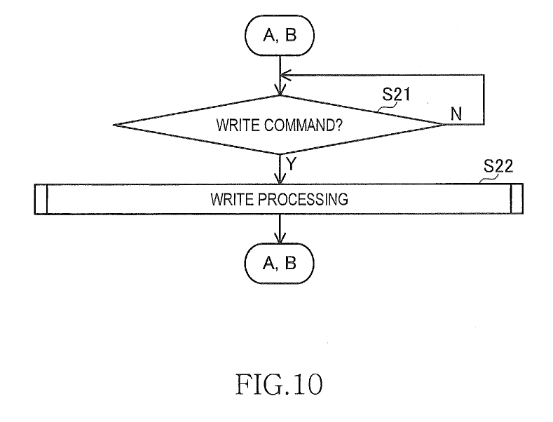

Next, as shown in FIG. 10, when a write command WRT is issued (step S21), the array control circuit 36 performs write processing (step S22). Here, in FIG. 10, the initial and end states are both denoted by (A, B). Such a denotation means that there are two possible situations, including where the processing starts at the state A (the state after the end of step S9 in FIG. 8) and returns to the state A, and where the processing starts at the state B (the state after the end of step S15 in FIG. 9) and returns to the state B. The same applies to the subsequent flowcharts.

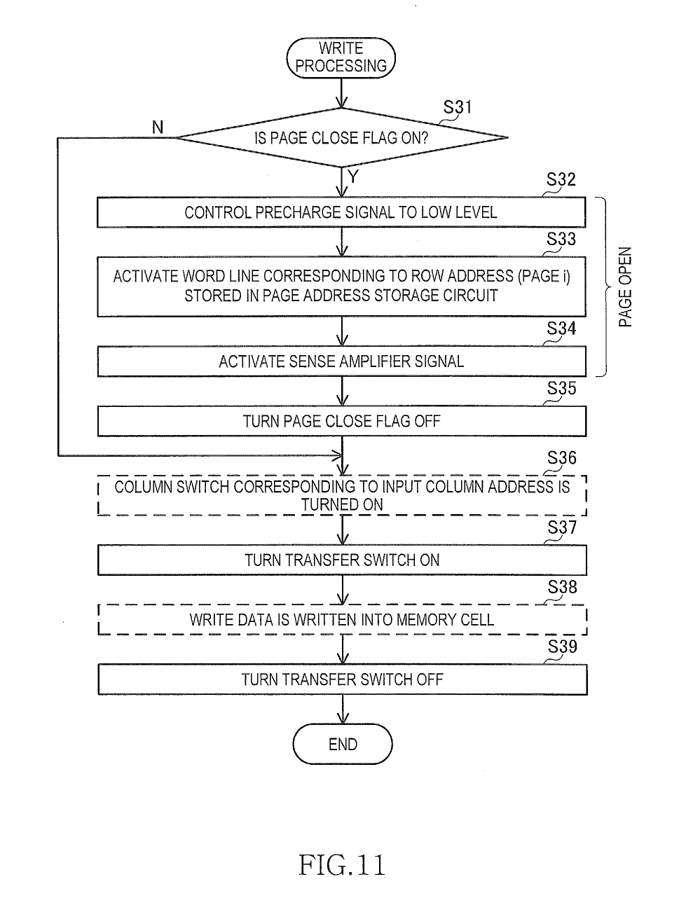

In the write processing, as shown in FIG. 11, the array control circuit 36 initially refers to the page close flag in the flag storage circuit 51 (step S31). If the page close flag is on, i.e., the page is in a closed state, the array control circuit 36 performs processing for opening the page (steps S32 to S34). Here, the array control circuit 36 acquires the row address XA of the page i to be opened from the page address storage circuit 50 (step S33). After the page i is opened, the array control circuit 36 turns off (inactive state) the page close flag in the flag storage circuit 51 (step S35). The processing of step S36 and subsequent steps is then performed.

If, in step S31, the page close flag is off, the processing of steps S32 to S35 is skipped to perform the processing of step S36 and the subsequent steps.

The processing of step S36 and the subsequent steps will be described. In step S36, the column decoder 25 turns on (connected state) the column switch 24 corresponding to the input column address. Next, the array control circuit 36 activates the transfer signal TC to turn on (connected state) the transfer switch 22 (step S38). As a result, the write data starts to be written to the memory cell MC (step S38). When the writing to the memory cell MC is completed, the array control circuit 36 deactivates the transfer signal TC to turn off (disconnected state) the transfer switch 22 (step S39). Although not shown in the flowchart, the column switch is also turned off (disconnected state). By the processing so far, a series of write operations is completed.

As described above, the semiconductor device 10 automatically opens the page to be written in response to the issuance of a write command WRT. With the semiconductor device 10, an act command or a row address need not be input for each write operation.

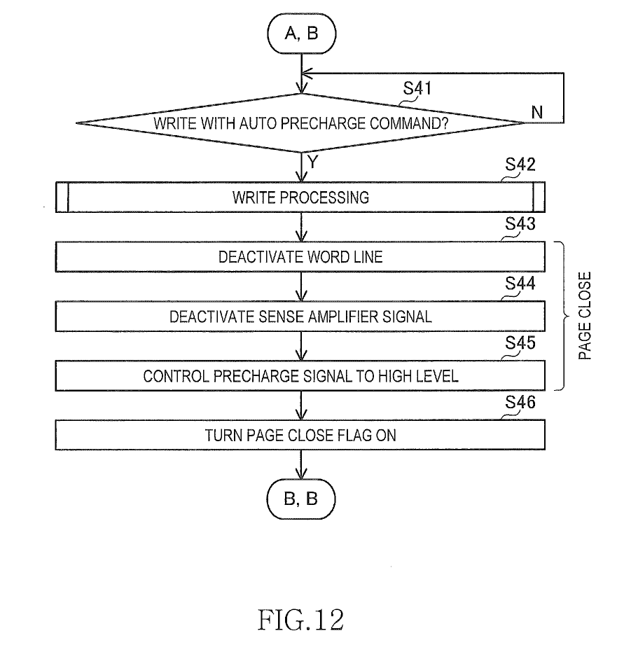

In case a write with auto precharge command WAP is issued as shown in FIG. 12 (step S41), the array control circuit 36 initially performs write processing (step S42). This processing is the same as described with reference to FIG. 11. After the completion of the write processing, the array control circuit 36 performs processing for closing the page i (steps S43 to S45). The details of the page close processing are as described above. After the page i is closed, the array control circuit 36 turns on (active state) the page close flag in the flag storage circuit 51 (step S46). In such a manner, a write with auto precharge command WAP can be used to make the semiconductor device 10 continuously perform a series of processes from a write to a page close.

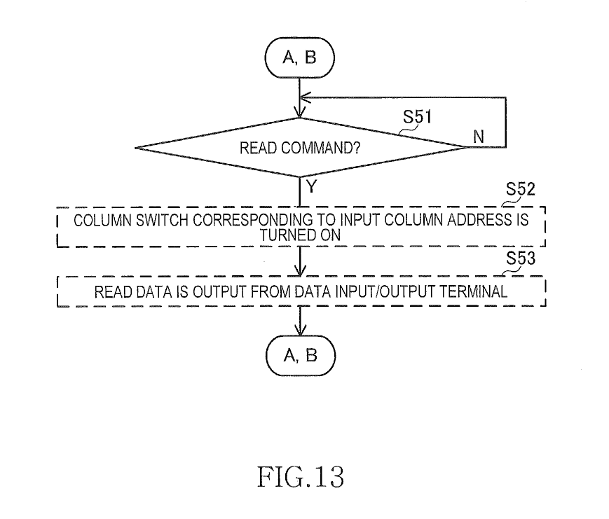

Turing to FIG. 13, at the time when a read command RED is issued (step S51), the data in the page has been copied into the row cache registers 23. As shown in FIG. 13, a read operation is thus performed by the processing of the column decoder 25 turning on (connected state) the column switch 24 designated by the input column address (step S52) and the processing of outputting the read data in the row cache register 23 from the data input/output terminal 16 (FIG. 1) (step S53). For a read operation, the array control circuit 36 performs no particular processing.

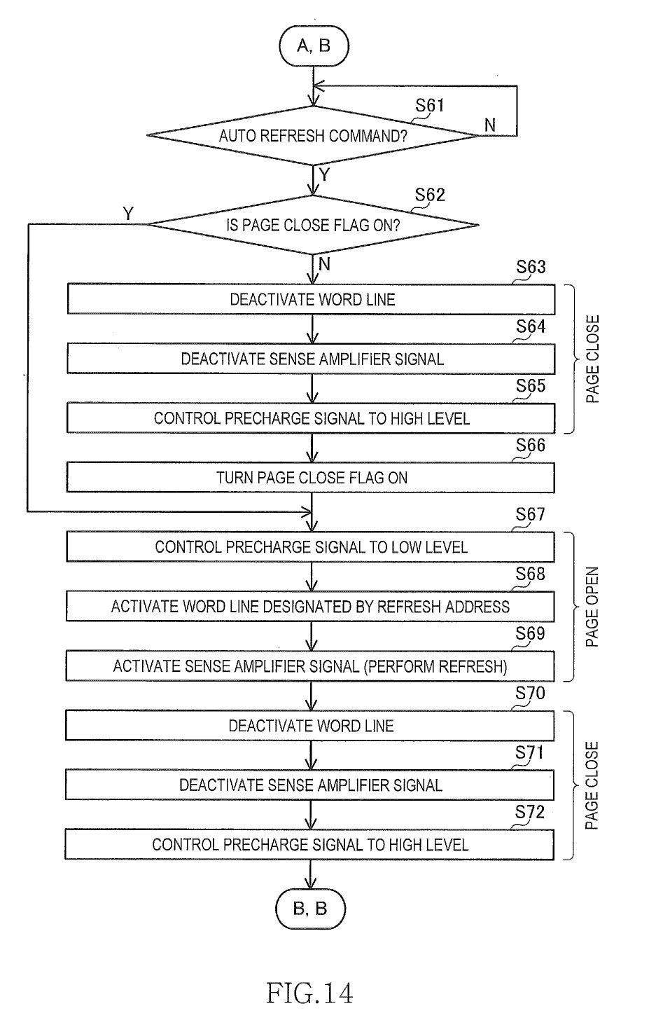

Turing to FIG. 14, if an auto refresh command REF is issued (step S61), the array control circuit 36 initially refers to the page close flag in the flag storage circuit 51 (step S62). If the page close flag is off, i.e., a page is in an opened state, the array control circuit 36 performs processing for closing the page (steps S63 to S65). The details of the page close processing are the same as described above. The reason for closing the page is that another page designated by a refresh address RA is to be opened. When in a period between the input of an act command ACT and the input of a precharge command PRE or if a write command WRT without an auto precharge is input, the page is maintained open and such processing is thus needed. After the page is closed, the array control circuit 36 turns on (active state) the page close flag in the flag storage circuit 51 (step S66).

Next, the array control circuit 36 performs processing for opening the page corresponding to the refresh address RA (steps S67 to S69). In step S69, the sense amplifier signal SA is activated to refresh the data in the corresponding memory cells MC. After the end of the refresh, the array control circuit 36 performs processing for closing the opened page (step S70 to S72).

In FIG. 14, the array control circuit 36 autonomously closes the page (steps S63 to S65) in response to the issuance of the auto refresh command REF. However, if a page is open before the input of an auto refresh command REF, a precharge command PRE may always be issued from outside.

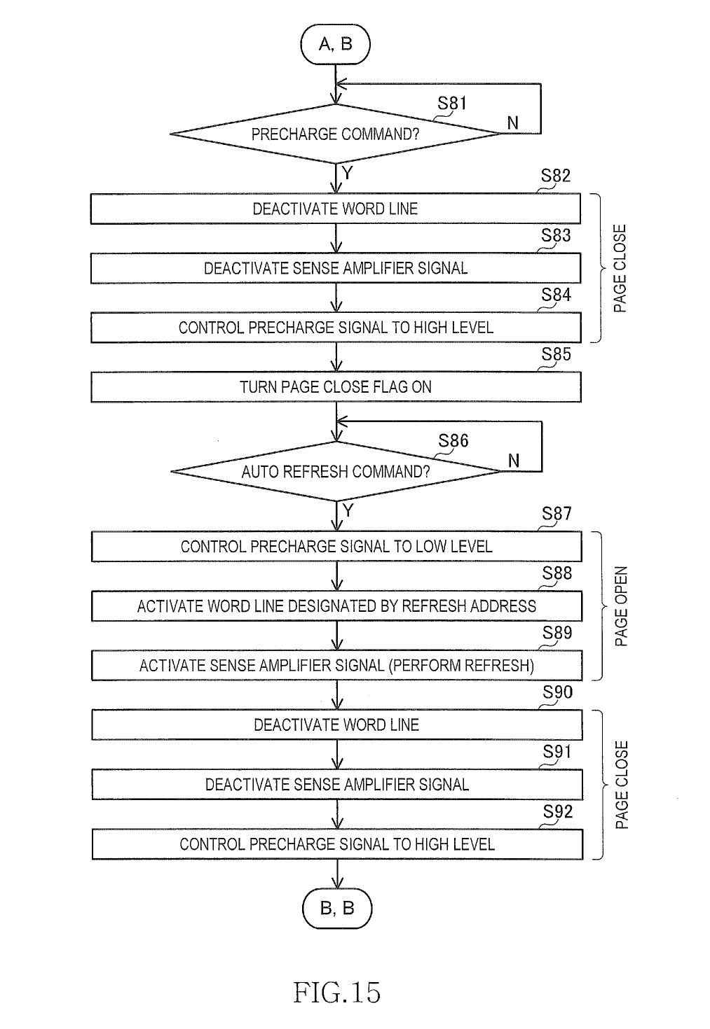

In such a modification, as shown in FIG. 15, processing according to a precharge command PRE (steps S82 to S85) is initially performed. Processing according to the auto refresh command REF (steps S87 to S92) is then performed. The processing of steps S81 to S85 is the same as that of steps S11 to S15 shown in FIG. 9. The processing of step S87 to S92 is the same as that of steps S61 and S67 to S72 shown in FIG. 14. A refresh according to an auto refresh command REF may be perform in such a manner.

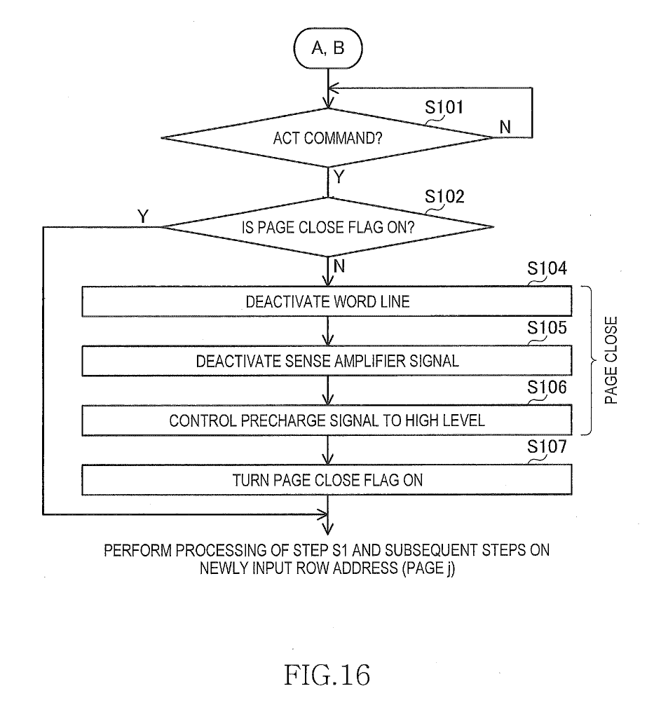

Turing to FIG. 16, when a new act command ACT is issued (step S101) after the series of processes shown in FIGS. 8 and 9, the array control circuit 36 initially refers to the page close flag in the flag storage circuit 51 (step S102). If the page close flag is off, i.e., a page is open, the array control circuit 36 performs processing for closing the page (steps S104 to S106). The details of the page close processing areas described above. After the page is closed, the array control circuit 36 turns on (active state) the page close flag in the flag storage circuit 51 (step S107). The processing of step S1 and the subsequent steps shown in FIG. 8 is then performed with a newly input address signal (assume it to be a row address designating page j).

As has been described above with reference to FIGS. 8 to 16, the semiconductor device 10 according to the present embodiment automatically opens a page if the page is closed at the time when a write command WRT is input. This eliminates the need for a write back. If an act command ACT is followed by a precharge command PRE or a write with auto precharge command WAP, the page is closed. Subsequently, a refresh operation can be performed even during a read operation corresponding to a read command RED.

To open a page for a write operation, the row address XA stored in the page address storage circuit 50 is used. This eliminates the need to input an act command and a row address for each write operation. The semiconductor device 10 according to the present embodiment thus maintains a memory access efficiency equivalent to that of conventional semiconductor devices that employ row cache registers.

Finally, the processing of the array control circuit 36 in a write operation will be described again from yet another viewpoint with reference to timing charts of various relevant signals.

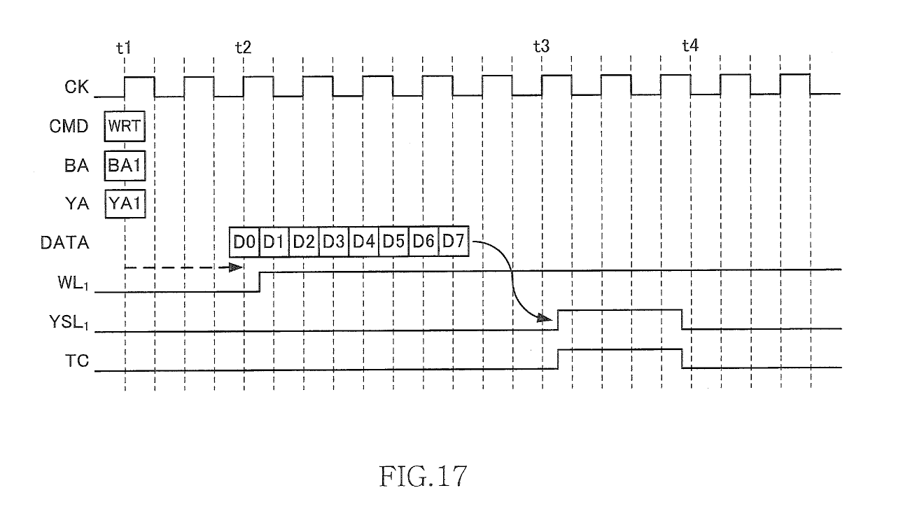

FIG. 17 shows a case where the page is closed at the time when the write command WRT is issued. As shown in FIG. 17, an external controller issues a write command WRT at time t1, and synchronously inputs a bank address BA and a column address YA to the semiconductor device 10. In FIG. 17, the bank address and the column address are denoted by BA1 and YA1, respectively.

Subsequently, at time t2 two clock cycles after time t1, the external controller starts to input write data DATA which includes eight bits D0 to D7. As shown in FIG. 17, the bits D0 to D7 are serially input to the data input/output terminal 16 (FIG. 1) at intervals of half clock cycles from time t2.

As described above, the array control circuit 36 performs processing for opening the page in response to the issuance of the write command WRT (FIG. 17 only shows the activation of the corresponding word line WL₁). At time t3, after the write data DATA has reached the column switch 24, the column decoder 25 activates the column switch signal YSL₁ corresponding to the column address YA1. Also, the array control circuit 36 activates the transfer signal TC. As a result, the I/O line pair IOLP and the memory cell MC are connected to write the write data DATA into the memory cell MC. After the end of the write processing, the column decoder 25 and the array control circuit 36 deactivate the column switch line YSL₁ and the transfer signal TC by time t4, respectively. A series of write operations are thereby completed.

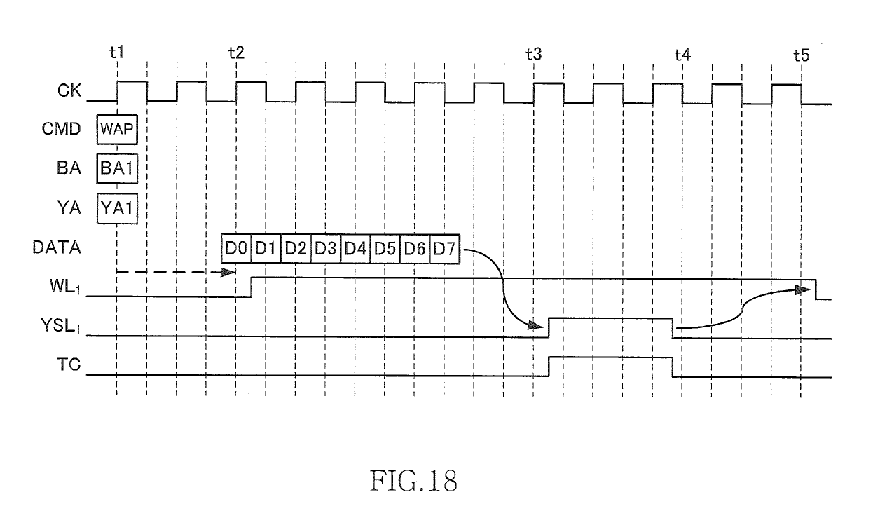

FIG. 18 shows a case where the page is closed at the time when the write with auto precharge command WAP is issued. A comparison between FIGS. 17 and 18 shows that the processing up to time t4 is the same as when a write command WRT is issued. In case the write with auto precharge command WAP is issued, the processing for closing the page is added at time t5 after time t4 (FIG. 17 only shows the deactivation of the corresponding word line WL₁). This makes it possible to subsequently perform an auto refresh or a page open without deliberately closing the page.

As has been described above, according to the semiconductor device 10 of the present embodiment, a write back becomes not needed since a page is once open for a write operation. This can ensure compatibility with semiconductor devices that use no row cache register. In a read operation, an auto refresh can be performed during a column access as with conventional semiconductor devices that use row cache registers.

Since an act command or a row command need not be input for each write operation, the semiconductor device 10 according to the present embodiment maintains a memory access efficiency equivalent to that of conventional semiconductor devices that use row cache registers.

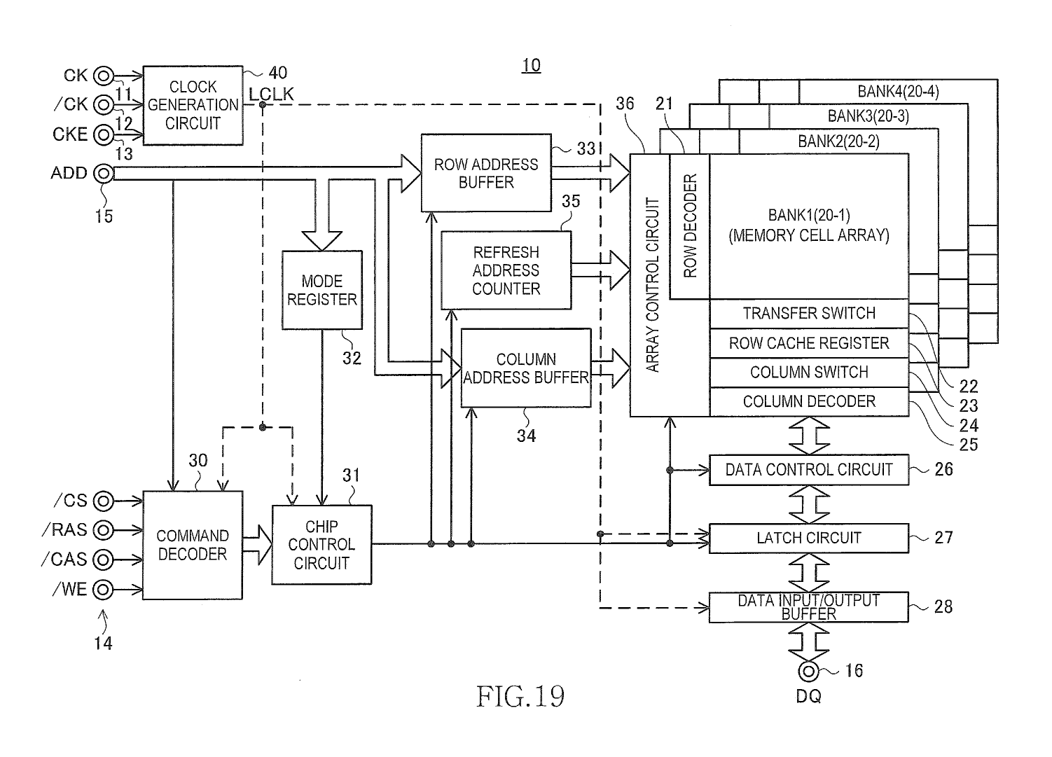

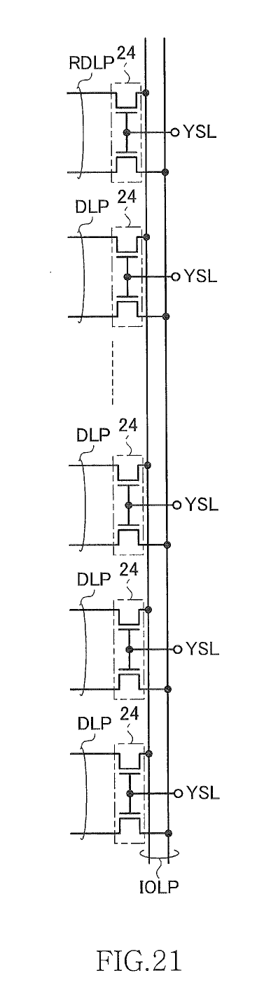

Turning to FIGS. 19 to 21, the semiconductor device 10 according to the second embodiment of the present invention is now described.

As is clear from a comparison of FIGS. 19 to 21 with FIGS. 1, 2, and 5, the semiconductor device 10 according to the present embodiment differs from the semiconductor device 10 according to the first embodiment in the following points. The semiconductor device 10 according to the present embodiment includes a redundant data line pair RDLP (first redundant data line) for relieving defective bit line pairs, and a plurality of data line pairs DLP including the redundant data line pair RDLP are connected to a single I/O line pair IOLP. The memory blocks 20-1A to 20-1D each include a redundant bit line pair RBLP which is a bit line pair BLP corresponding to the redundant data line pair RDLP. The array control circuit 36 includes row address generation circuits 56ᵢ, 56ⱼ, . . . , 56₀, row address storage circuits 57ᵢ and 57ⱼ, address comparison circuits 52A to 52D, and defective address information storage circuits 53A to 53D (first defective address information storage circuit) in addition to the page address storage circuit 50 and the flag storage circuit 51 shown in FIG. 2. The address signal buffered in the column address buffer 34 is supplied to the column decoder 25 through the array control circuit 36. In other respects, the semiconductor device 10 according to the present embodiment is the same as the semiconductor device 10 according to the first embodiment. Similar components will be designated by the same reference symbols, and a detailed description thereof will be omitted. In the following description, a block address shall include two bits Xᵢ and Xᵢ of the row address XA (Xᵢ, Xⱼ, . . . , X₀).

According to the semiconductor device 10 of the present embodiment, the block address Xᵢ and Xᵢ is stored in the row address storage circuits 57ᵢ and 57ᵢ. Defective bit lines can thus be determined memory block by memory block. This can improve the efficiency for relieving defective bit lines. A detailed description will be given below.

The row address generation circuits 56ᵢ, 56ⱼ, . . . , 56₀ are circuits that generate a row address XDA (XDᵢ, XDⱼ, . . . , XD₀) designating a word line WL to be activated. When either an internal act command ACT or an internal refresh command REF is input from the chip control circuit 31 (FIG. 19), the array control circuit 36 supplies the generated row address XDA to the row decoders 21 arranged at the end of the respective memory blocks 20-1A to 20-1D. The row decoders 21 activate a word line WL designated by the supplied row address XDA.

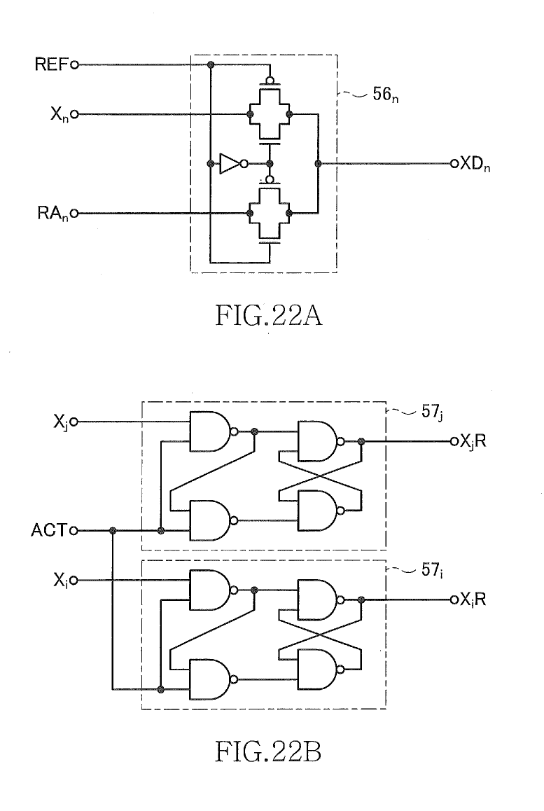

Turning to FIG. 22A, the reference symbol RAₙ (n=j, . . . , 0) shown in the diagram represents a bit corresponding to the row address generation circuit 56ₙ of the refresh address RA generated by the foregoing refresh address counter 35.

As can be seen from the circuit configuration shown in FIG. 22A, the row address generation circuit 56ₙ outputs the refresh address RAₙ as the generated row address XDₙ if the internal auto refresh command REF is activated. On the other hand, if the internal auto refresh command REF is not activated, the row address generation circuit 56ₙ outputs the row address Xₙ as the generated row address XDₙ. Such a configuration of the row address generation circuit 56ₙ makes it possible to refresh memory cells MC according to the auto refresh command REF.

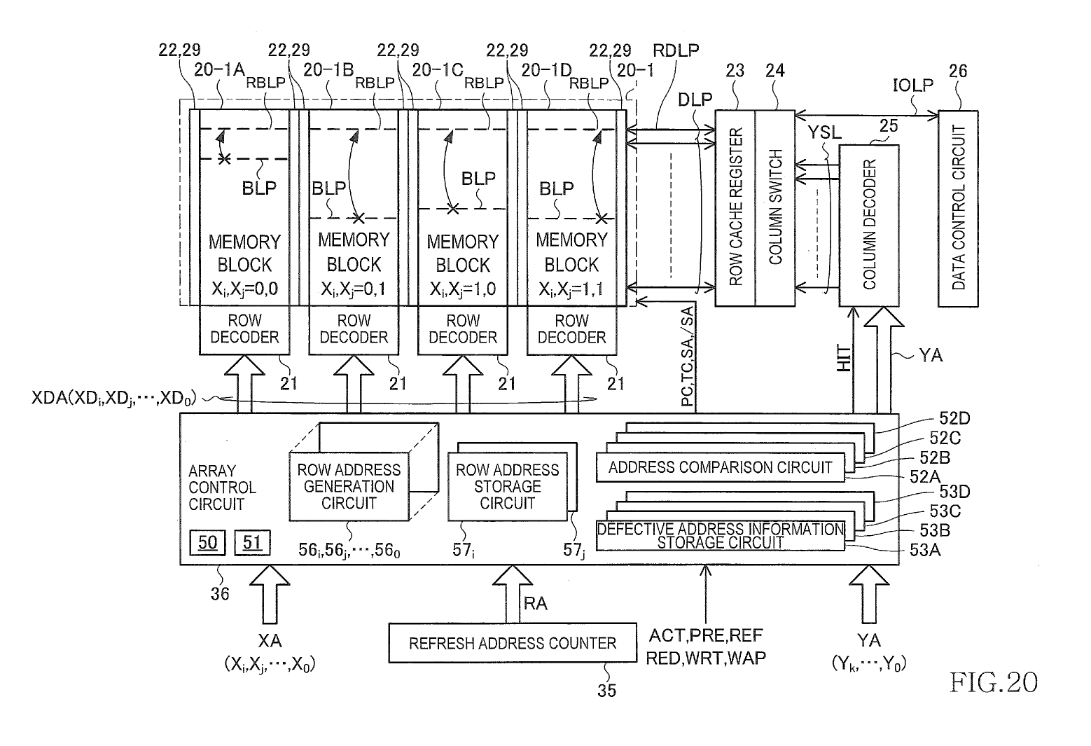

Returning to FIG. 20, the row address storage circuits 57ᵢ and 57ⱼ are circuits that store only the block address Xᵢ and Xⱼ, respectively, of the row address XA (Xᵢ, Xⱼ, . . . , X₀) input in synchronization with an act command ACT.

As shown in FIG. 22B, the row address storage circuit 57ᵢ is a D-type latch circuit. The row address storage circuit 57i has the function of acquiring and storing the block address Xᵢ when the internal act command ACT is activated, and retaining the acquired block address Xᵢ after the internal act command ACT is deactivated until the next activation. The same holds for the row address storage circuit 57j. The outputs of the row address storage circuits 57ᵢ and 57ⱼ are supplied to the address comparison circuits 52A to 52D to be described later as a block address XᵢR and XⱼR, respectively.

Returning to FIG. 20, the address comparison circuits 52A to 52D and the defective address information storage circuits 53A to 53D are circuits to be used to determine whether a bit line pair BLP to make a column access to is a defective bit line pair or not. In the present embodiment, such a determination is performed memory block by memory block. The determination result is supplied to the column decoder 25 as a hit signal HIT.

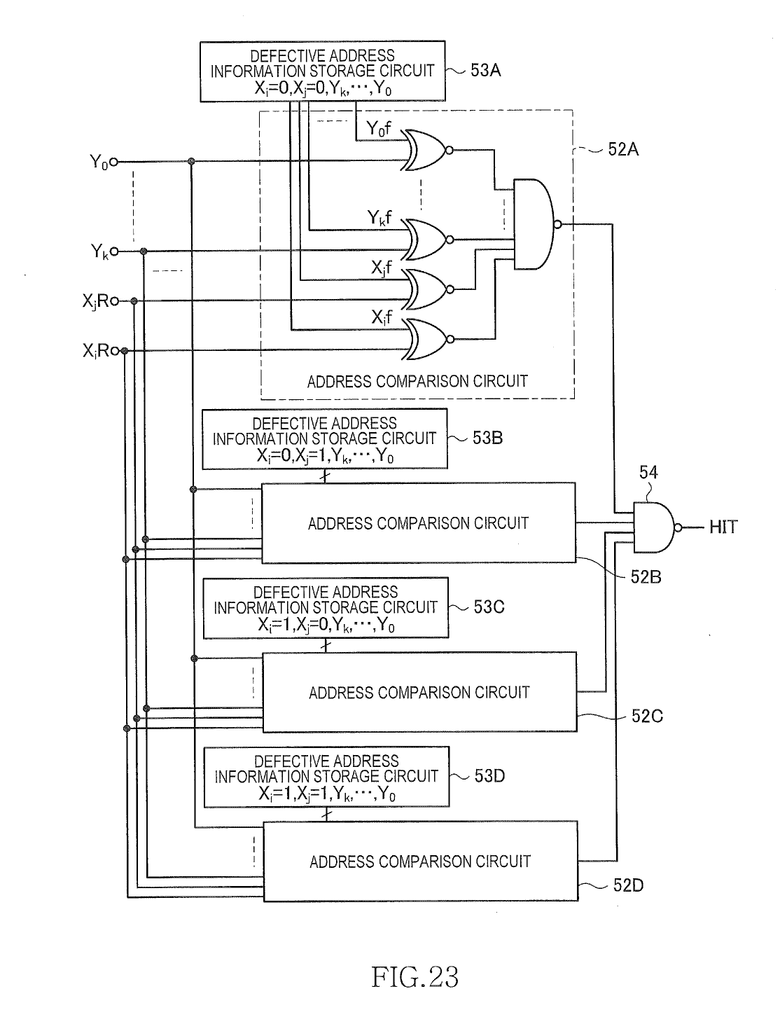

As shown in FIG. 23, the array control circuit 36 includes a NAND circuit 54 aside from such circuits.

As shown in FIG. 23, the defective address information storage circuits 53A to 53D store address information (Xᵢ, Xⱼ, Yₖ, . . . , Y₀; hereinafter, referred to as “first address information”) that indicates a combination of a column address YA designating a defective bit line pair BLP and the block address Xᵢ and Xⱼ of the memory block to which the defective bit address pair BLP belongs. The defective address information storage circuits 53A to 53D are arranged to correspond to the memory blocks 20-1A to 20-1D, respectively. As shown in FIG. 23, the block addresses Xᵢ and Xⱼ to be stored in the defective address information storage circuits 53A to 53D are predetermined to be the block addresses designating the respective corresponding memory blocks. The number of defective address information storage circuits corresponding to each memory block is one because the number of redundant bit line pairs RBLP in each memory block is one.

The defective address information circuits 53A to 53D store the first address information by using not-shown fuse elements. The fuse elements are provided for respective bits of the first address information, and each store one bit of information in terms of their conducting state (whether conducting or not-conducting). The first address information is written to the defective address information storage circuits 53A to 53D (a processing to blow the fuse elements) as appropriate when the semiconductor device 10 is manufactured. It should be appreciated that the block addresses Xᵢ and Xⱼ need not necessarily be stored by using fuse elements since the block addresses Xᵢ and Xⱼ to be stored in the respective defective address information storage circuits are predetermined as described above. Also, anti-fuse elements may be used instead of fuse elements.

When a column address YA is input from outside, the address comparison circuit 52A acquires address information (hereinafter, referred to as “second address information”) that indicates a combination of the column address YA and the block address XᵢR and XⱼR stored in the row address storage circuits 57ᵢ and 57ⱼ. The address comparison circuit 52A then compares the second address information with the first address information stored in the defective address information storage circuit 53A. More specifically, as shown in FIG. 23, the address comparison circuit 52A is configured to compare the pieces of address information bit by bit, and if all the bits coincide, output a low level, and otherwise output a high level. The same holds for the address comparison circuits 52B to 52D.

The output signals of the address comparison circuits 52A to 52D are all supplied to the NAND circuit 54. The NAND circuit 54 generates a hit signal HIT indicating the comparison result of the address information based on the supplied four output signals. Specifically, if any one of the four output signals is at a low level (coincidence), the NAND circuit 54 generates the hit signal HIT of high level (coincidence). If all the four outputs are at a high level (no coincidence), the NAND circuit 54 generates the hit signal HIT of low level (no coincidence). With the configuration of FIG. 23, the case where two or more of the output signals become a low level (coincidence) at the same time could never happen.

Returning to FIG. 20, the array control circuit 36 supplies the hit signal HIT generated as described above and the column address YA supplied from the column address buffer 34 (FIG. 19) to the column decoder 25. If the hit signal is at a low level (no coincidence), the column decoder 25 brings the column switch 24 designated by the supplied column address YA into a connected state. Consequently, the data line pair DLP designated by the supplied column address YA is connected to the I/O line pair IOLP, and the row cache register 23 connected to the data line pair DLP becomes accessible from outside. On the other hand, if the hit signal is at a high level (coincidence), the column decoder 25 brings the column switch 24 corresponding to the redundant data line pair RDLP into a connected state. Consequently, the redundant data line pair RDLP is connected to the I/O line pair IOLP, and the row cache register 23 connected to the redundant data line pair RDLP becomes accessible from outside.

As has been described above, according to the semiconductor device 10 of the present embodiment, the block address X₁ and Xⱼ is stored in the row storage circuits 57ᵢ and 57ⱼ. And address information including the block address Xᵢ and Xᵢ (Xᵢ, Xᵢ, Yₖ, . . . , Y₀) is compared to determine a defective bit line pair BLP. This makes it possible to determine a defective bit line pair BLP memory block by memory block.

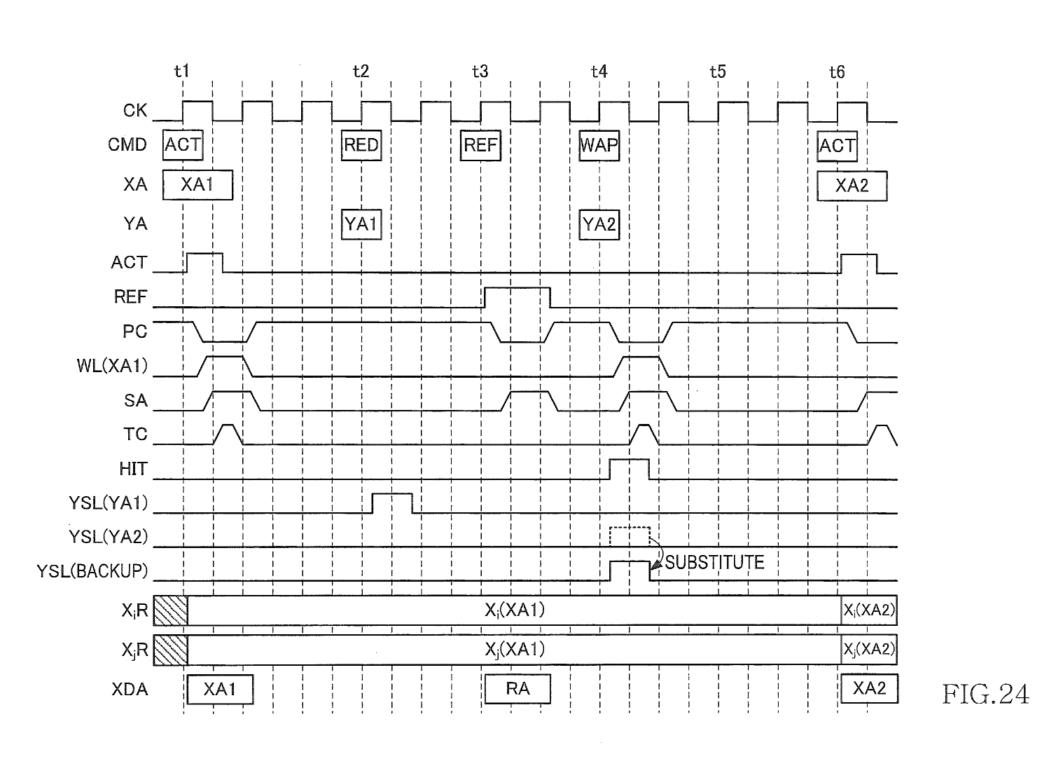

Next, an overall picture of the operation of the array control circuit 36 will be given below in conjunction with the specific case shown in FIG. 24 and with reference to FIG. 20.

In response to that an act command ACT is supplied from outside at time t1 and a row address XA1 is further supplied in synchronization with the act command ACT, the chip control circuit 31 (FIG. 19) activates an internal act command ACT. In response, the array control circuit 36 deactivates the precharge signal PC for a predetermined period. While the precharge signal PC is inactive, as is evident from FIG. 4, the supply of the power supply voltage VDD/2 to the bit line pairs BLP is stopped and an equalization of the bit line pairs BLP is also stopped. After the predetermined period has elapsed and the precharge signal PC has returned to an active state, the bit line pairs BLP returns to a precharge state. Also, the array control circuit 36 outputs a row address XDA generated by the row address generation circuits 56ᵢ, 56₁, . . . , 56₀ to the row decoders 21. The row address XDA here is the same as the row address XA1. The row decoders 21 activate a word line WL(XA1) designated by the row address XDA for a predetermined period after the input of the row address XDA is started. As a result, the page corresponding to the word line WL(XA1) is opened and small changes corresponding to the memory contents (read data) of the memory cells MC connected to the word line WL(XA1) occur in the potentials of the respective bit line pairs BLP. After the predetermined period has elapsed and the word line WL(XA1) has returned to an inactive state, the page corresponding to the word line WL(XA1) is closed.

Next, the array control circuit 36 activates the sense amplifier signal SA for a predetermined period. A potential difference between the two bit lines BL constituting each of the bit line pairs BLP is thereby amplified to the power supply voltage VDD. The array control circuit 36 then activates the transfer signal TC for a predetermined period. While the transfer signal TC is in an active state, the transfer switches 22 is in a connected state, and the read data on the bit line pairs BLP is copied to the data line pair DLP. After the transfer signal TC has returned to an inactive state, the row cache register 23 becomes in an operating state, and the read data on the data line pair DLP is stored into the row cache registers 23. This is equivalent to that the memory contents of the memory cells MC (page) corresponding to the word line WL(XA1) are copied into the row cache registers 23. After the transfer signal TC has returned to an inactive state, the row cache registers 23 are disconnected from the bit line pairs BLP, which makes it possible to perform a refresh operation according to an auto refresh command REF as will be described later. The timing to deactivate the transfer signal TC is preferably between when the data on the bit line pairs BLP is stored into the row cache registers 23 and when the precharge signal PC is activated.

In response to the activation of the internal act command ACT, the array control circuit 36 stores the block address Xᵢ(XA1) and Xⱼ(XA1) included in the row address XA1 supplied in the same period into the row address storage circuits 57ᵢ and 57ⱼ. The row address storage circuits 57ᵢ and 57ⱼ subsequently keep the memory contents until the act command ACT is activated the next time.

Next, at time t2, a read command RED is supplied from outside. A column address YA1 is further supplied in synchronization with the read command RED. The chip control circuit 31 (FIG. 19) activates the internal read command RED. In response, the array control circuit 36 performs the foregoing processing for generating the hit signal HIT on the first address information that includes the supplied column address YA1 and the block address Xᵢ(XA1) and Xⱼ(XA1) stored in the row address storage circuits 57ᵢ and 57ⱼ. The hit signal HIT here is at a low level (no coincidence). Receiving the input of the hit signal HIT and the column address YA1, the column decoder 25 activates the column switch line YSL(YA1) corresponding to the column address YA1. As a result, the row cache register 23 corresponding to the column address YA1 is connected to the data control circuit 26 through the I/O line pair IOLP. Subsequently, the memory contents of the row chance register 23 are output to outside as read data DQ through the data input/output terminal 16 (FIG. 19) by the processing of the data processing circuit 26 etc.

Next, at time t3, an auto refresh command REF is supplied from outside. The chip control circuit 31 (FIG. 19) activates an internal auto refresh command REF. In response, the array control circuit 36 deactivates the precharge signal PC for a predetermined period, and activates the word line WL (not shown) designated by the refresh address RA for a predetermined period. The array control circuit 36 further activates the sense amplifier signal SA for a predetermined period. As a result, the memory contents of the memory cells MC corresponding to the word line WL are refreshed. The array control circuit 36 will not activate the transfer signal TC here. The refresh operation therefore has no effect on the memory contents of the row cache registers 23. After the predetermined period has elapsed and the precharge signal PC has returned to an active state, the bit line pairs BLP returns to a precharge state. Also, after the predetermined period has elapsed and the word line WL has returned to an inactive state, the page corresponding to the word line WL is closed.

Next, at time t4, a write with auto precharge command WAP is supplied from outside. A column address YA2 is further supplied in synchronization with the write with auto precharge command WAP. The chip control circuit 31 (FIG. 19) activates an internal write with auto precharge command WAP. In response, the array control circuit 36 initially performs, concerning the column system, the foregoing processing for generating the hit signal HIT on the first address information that includes the supplied column address YA2 and the block address Xᵢ(XA1) and Xⱼ(XA1) stored in the row address storage circuits 57ᵢ and 57ⱼ. The hit signal HIT here is at a high level (coincidence). Receiving the input of the hit signal HIT and the column address YA2, the column decoder 25 activates the column switch line YSL(backup) corresponding to the redundant data line pair RDLP instead of the column switch line YSL(YA2) corresponding to the column address YA2. As a result, the row cache register 23 corresponding to the redundant data line pair RDLP is connected the data control circuit 26 through the I/O line pair IOLP. As for the row system, the array control circuit 36 performs the foregoing control shown in FIGS. 11 and 12. As a result of such control, the memory contents of the row cache register 23 are rewritten with write data DQ input from the data input/output terminal 16 (FIG. 1) by the processing of the data control circuit 26 etc. The memory contents of the corresponding memory cell MC are also rewritten.

Subsequently, at time t6, an act command ACT is input from outside, and the memory contents of the row address storage circuits 57ᵢ and 57ⱼ are rewritten with a newly input row address XA2. Since the rest of the processing is the same as the foregoing, a detailed description will be omitted.

As has been described above, according to the semiconductor device 10 of the present embodiment, defective bit line pairs BLP can be determined memory block by memory block. The defective bit line pairs BLP can thus be relieved memory block by memory block. This improves the efficiency for relieving defective bit line pairs BLP as compared to heretofore.

Also, the row address generation circuits 56ᵢ, 56ⱼ, . . . , 56₀ are configured to output the refresh address RA as the row address XDA if the internal auto refresh command REF is activated, and otherwise output the row address XA as the row address XDA. This makes it possible to refresh the memory cells MC according to an auto refresh command REF.

The present embodiment has dealt with the case where there is only one redundant data line pair RDLP. However, a plurality of redundant data line pairs may be provided. For example, if the semiconductor device 10 includes first and second redundant data line pairs RDLP (first and second redundant data lines), the array control circuit 36 includes two sets of defective address information storage circuits 53A to 53D (first and second defective address information storage circuits). If the second address information (information indicating a combination of the column address YA input from outside and the block address XᵢR and XⱼR stored in the row address control circuits 57ᵢ and 57ⱼ) does not coincide with either one of the pieces of first address information stored in the respective first and second defective address information storage circuits, then the array control circuit 36 brings the column switch 24 designated by the column address input from outside into a connected state. On the other hand, if the second address information coincides with the first address information stored in the first defective address information storage circuit, the array control circuit 36 brings the column switch 24 corresponding to the first redundant data line pair RDLP into a connected state. If the second address information coincides with the first address information stored in the second defective address information storage circuit, the array control circuit 36 brings the column switch 24 corresponding to the second redundant data line pair RDLP into a connected state. In such a manner, a plurality of redundant data line pairs RDLP can be prepared for each memory block for improved relieving efficiency.

The present embodiment has dealt with the case of using a write with auto precharge command WAP. However, a write command WRT may be used. In such a case, after the end of the writing of write data DQ to memory cells MC, a precharge command PRE may be input to explicitly close the page. The page may be maintained open until an auto refresh command REF or act command ACT is subsequently input. The same holds for third and fourth embodiments to be described later.

The present embodiment has also dealt with the case where the power supply voltage VDD is directly supplied to one of the power supply nodes of the two CMOS inverters constituting the row cache register 23 without a P-channel MOS transistor, and the other power supply node is directly grounded without an N-channel MOS transistor. However, like the first embodiment, the power supply voltage VDD may be supplied to one of the power supply nodes of the two CMOS transistors constituting the row cache register 23 through a P-channel MOS transistor, and the other power supply node may be grounded through an N-channel MOS transistor. The same holds for the third to sixth embodiments to be described below.

In the present embodiment, the row address storage circuits 57ᵢ and 57ⱼ are provided separately from the page address storage circuit 50. Since the page address storage circuit 50 stores the row address XA (Xᵢ, Xⱼ, . . . , X₀) including the block address Xᵢ and Xⱼ, the page address storage circuit 50 may be used as the row address storage circuits 57ᵢ and 57ⱼ.

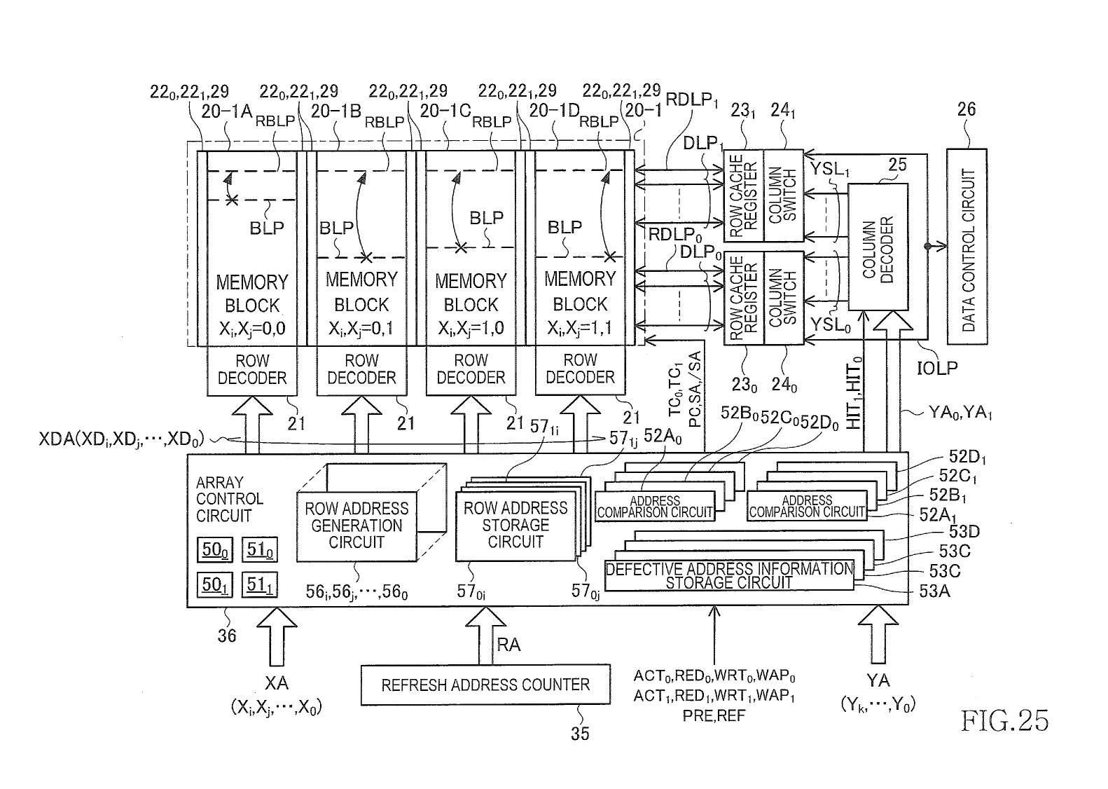

Turing to FIG. 25, the semiconductor device 10 according to the third embodiment of the present invention differs from the semiconductor device 10 according to the second embodiment in that first and second transfer switches 22₀ and 22₁, first and second row cache registers 23₀ and 23₁, first and second column switches 24₀ and 24₁, row address storage circuits 57₀ᵢ and 57₀ⱼ (first row address storage circuit), row address storage circuits 57₁ᵢ and 57₁ⱼ (second row address storage circuit), address comparison circuits 52A₀ to 52D₀ (first address comparison circuit), address comparison circuits 52A₁ to 52D₁ (second address comparison circuit), first and second data line pairs DLP₀ and DLP₁, first and second column switch lines YSL₀ and YSL₁, page address storage circuits 50₀ and 50₁, and flag storage circuits 51₀ and 51₁ are included instead of the transfer switches 22, row cache registers 23, column switches 24, row address storage circuits 57ᵢ and 57ⱼ, address comparison circuits 52A to 52D, data line pairs DLP, column switch lines YSL, page address storage circuit 50, and flag storage circuit 51. In short, such components are provided in twos for each of the corresponding components of the semiconductor device 10 according to the second embodiment. Various types of commands such as an act command and a write command are also allocated in twos for the respective sets. The semiconductor device 10 according to the present embodiment is thus configured to be able to open two pages in parallel. A detailed description will be given below with a focus on the differences.

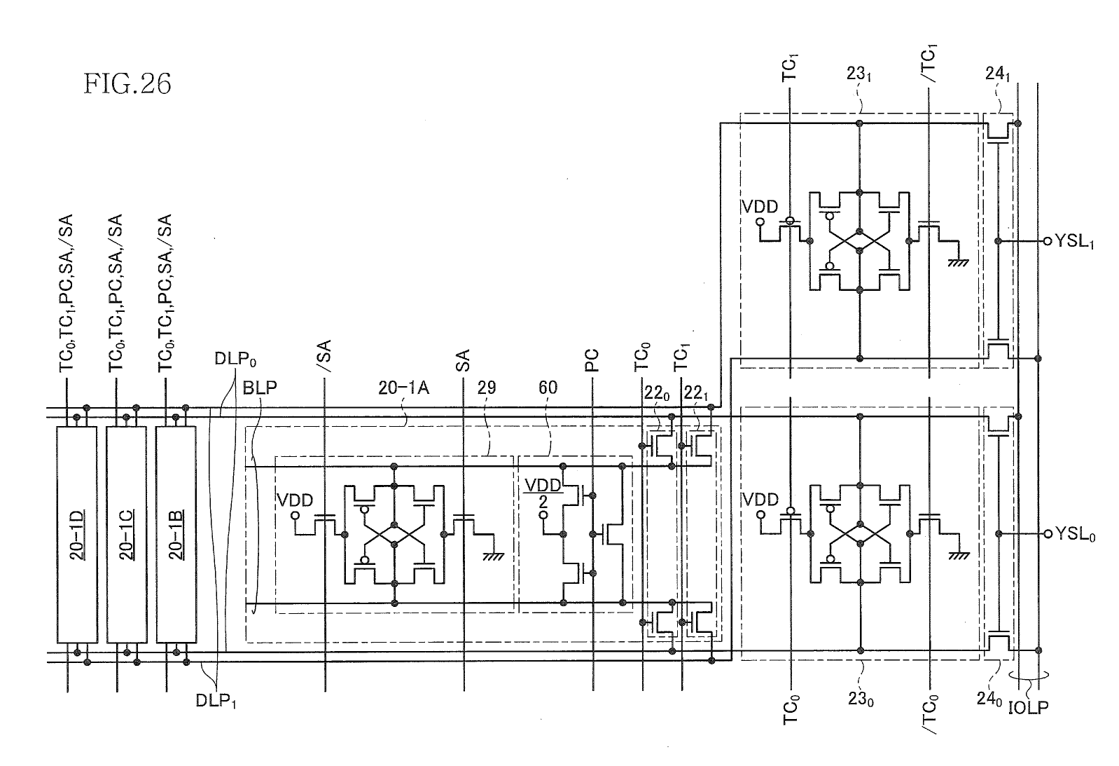

As shown in FIG. 26, the data line pairs DLP₀ and DLP₁ are connected to the same bit line pair BLP in the memory block 20-1A through the transfer switches 22₀ and 22₁ in the memory block 20-1A, respectively. The transfer switches 22₀ and 22₁ each have the same structure and function as those of the transfer switch 22 described in the second embodiment. The connection states of the transfer switches 22₀ and 22₁ are controlled by transfer signals TC₀ and TC₁, respectively.

The data line pairs DLP₀ and DLP₁ are connected to the same I/O line pair IOLP through the column switches 24₀ and 24₁, respectively. The column switches 24₀ and 24₁ each have the same structure and function as those of the column switch 24 described in the second embodiment. The connection states of the column switches 24₀ and 24₁ are controlled by the potentials of the column switch lines YSL₀ and YSL₁, respectively.

The data line pairs DLP₀ and DLP₁ are connected with the row cache registers 23₀ and 23₁, respectively. The row cache registers 23₀ and 23₁ each have the same structure and function as those of the row cache register 23 described in the second embodiment.

The configuration of FIG. 26 may be modified as follows: The transfer switches 22₀ and 22₁ are replaced with a single transfer switch 22 shown in FIG. 4. The data line pairs DLP₀ and DLP₁ are replaced with a single data line pair DLP. The transfer switches 22₀ and 22₁ are then arranged between the data line pair DLP and the row cache registers 23₀ and 23₁, respectively. The use of such a configuration provides the effect that the number of transfer switches 22 can be reduced due to the use of only one data line pair.

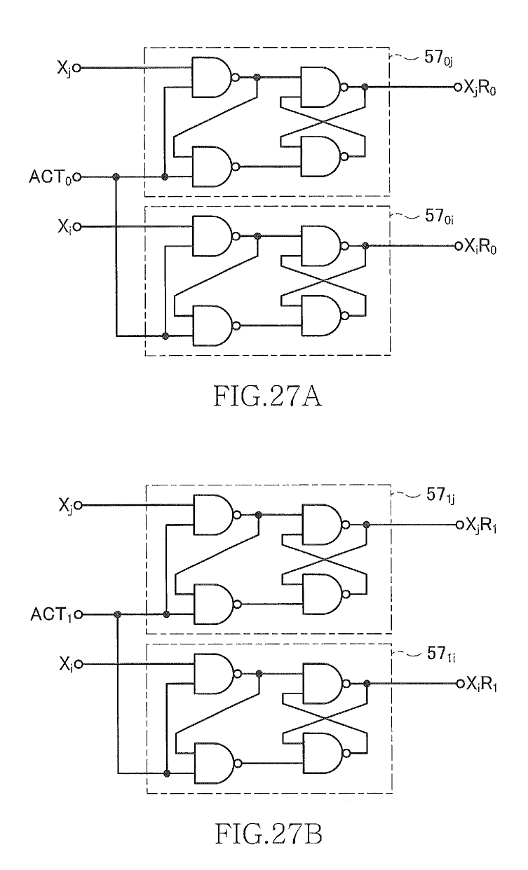

As can be seen from FIG. 27A, the row address storage circuits 57₀ᵢ and 57₀ⱼ differ from the row address storage circuits 57ᵢ and 57ⱼ shown in FIG. 22B in that an internal act command ACT₀ is supplied instead of the internal act command ACT. Similarly, as can be seen from FIG. 27B, the row address storage circuits 57₁ᵢ and 57₁ⱼ differ from the row address storage circuits 57ᵢ and 57ⱼ shown in FIG. 223 in that an internal act command ACT₁ is supplied instead of the internal act command ACT. In other respects, the row address storage circuits 57₀ᵢ and 57₀ⱼ and the row address storage circuits 57₁ᵢ and 57₁ⱼ are the same as the row address storage circuits 57ᵢ and 57ⱼ according to the second embodiment. The outputs of the row address storage circuits 57₀ᵢ and 57₀ⱼ are supplied to the address comparison circuits 52A₀ to 52D₀ to be described later as a block address XᵢR₀ and XⱼR₀, respectively. The outputs of the row address storage circuits 57₁ᵢ and 57₁ⱼ are supplied to the address comparison circuits 52A₁ to 52D₁ to be described later as a block address X₁R₁ and XⱼR₁, respectively.

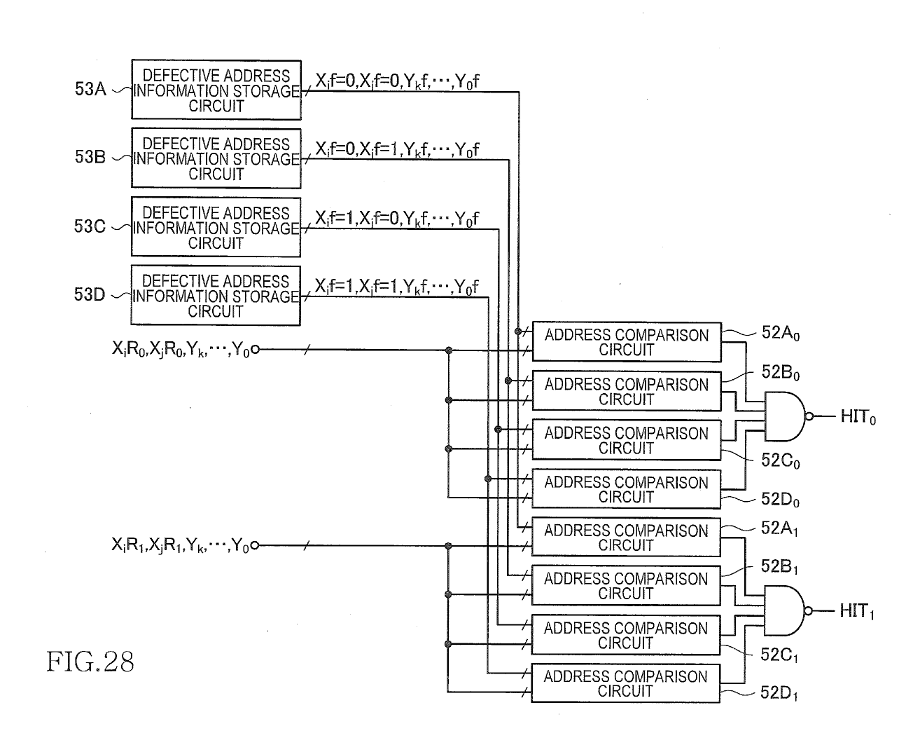

Turning to FIG. 28, though internal configurations of the address comparison circuits 52A₀ to 52D₀ and 52A₁ to 52D₁ are not shown in the diagram, each of the address comparison circuits 52A₀ to 52D₀ and 52A₁ to 52D₁ has the same circuit configuration as that of the address comparison circuit 52A shown in FIG. 23.

The address comparison circuits 52A₀ to 52D₀ play the same role as that of the address comparison circuits 52A to 52D except that the block address XᵢR₀ and XⱼR₀ is supplied instead of the block address XᵢR and XⱼR. The comparison results of the address information by the address comparison circuits 52A₀ to 52D₀ are output as a first hit signal HIT₀. Similarly, the address comparison circuits 52A₁ to 52D₁ play the same role as that of the address comparison circuits 52A to 52D except that the block address XᵢR₁ and XⱼR₁ is supplied instead of the block address XᵢR and XⱼR. The comparison results of the address information by the address comparison circuits 52A₁ to 52D₁ are output as a second hit signal HIT₁.

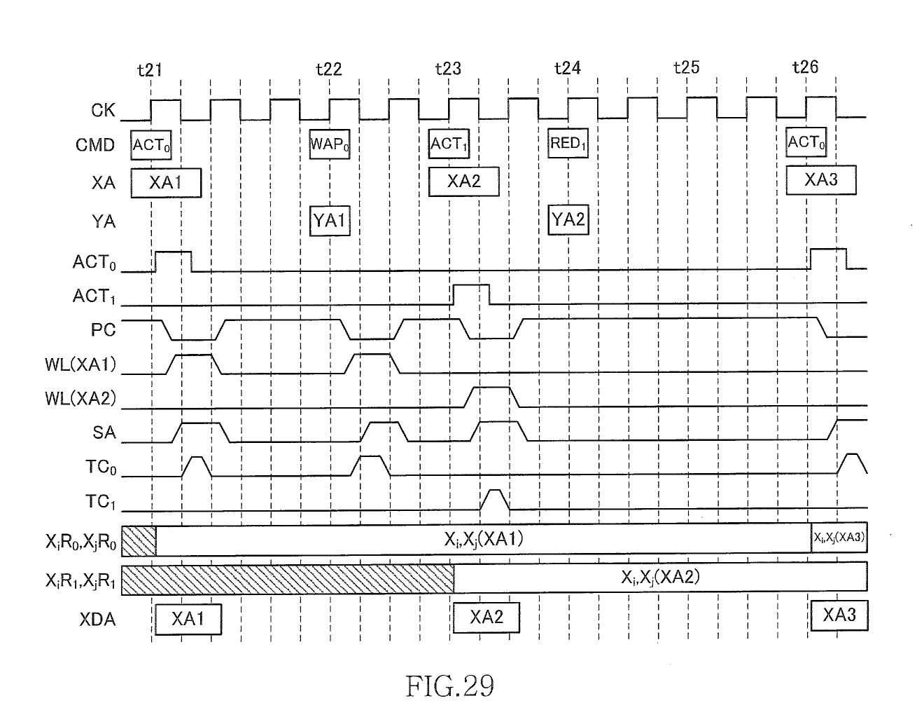

The operation of the array control circuit 36 according to the present embodiment will be described below in conjunction with the specific case shown in FIG. 29 and with reference to FIG. 25.

At time t21, an act command ACT₀ (first act command) is supplied from outside. A row address XA1 is further supplied in synchronization with the act command ACT₀. The chip select circuit 31 (FIG. 19) activates the internal act command ACT₀. In response, the array control circuit 36 deactivates the precharge signal PC for a predetermined period, and outputs the row address XA1 serving as a row address XDA to the row decoders 21. This activates the word line WL(XA1). The array control circuit 36 further activates the sense amplifier signal SA for a predetermined period, and activates the transfer signal TC₀. As a result, the memory contents of the memory cells MC (page) corresponding to the word line WL(XA1) are copied into the row cache registers 23₀. After the end of the copying, the array control circuit 36 deactivates the transfer signal TC₀.

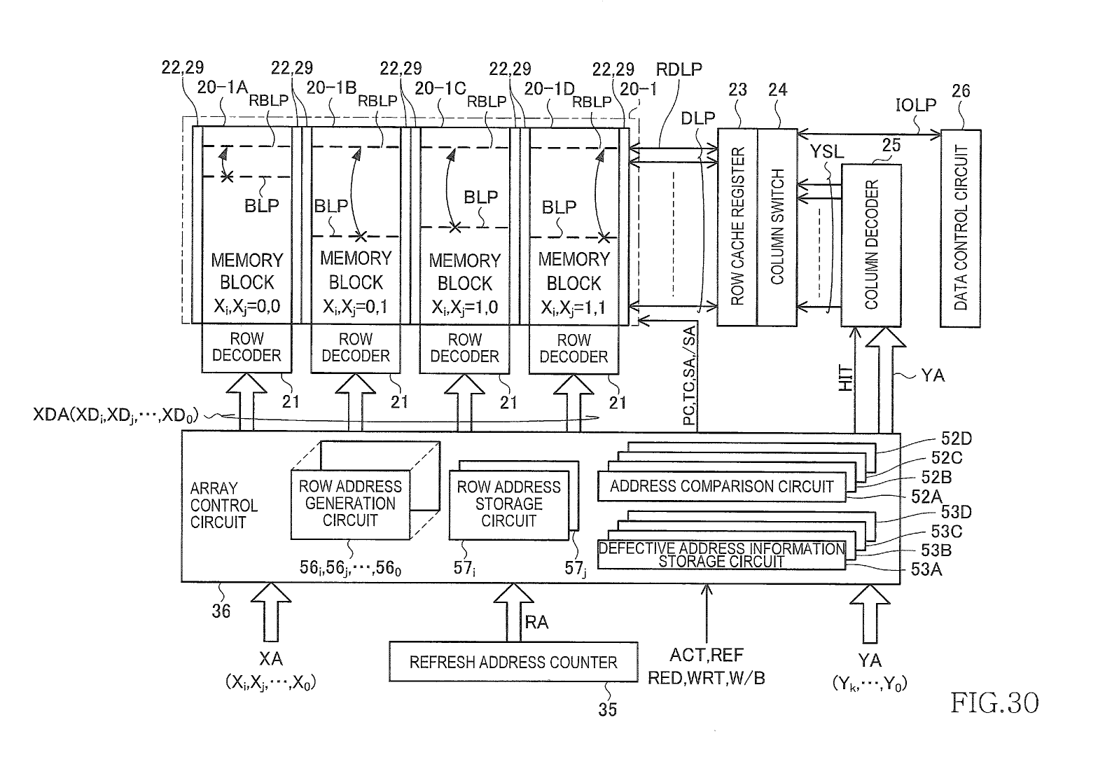

The row address XA1 supplied along with the act command ACT₀ includes a block address Xᵢ and Xⱼ, which is stored into the row address storage circuits 57₀ᵢ and 57₀ⱼ. Although not shown in FIG. 29, the array control circuit 36 writes the row address XA1 into the page address storage circuit 50₀, and turns off the page close flag on the flag storage circuit 51₀ (see FIG. 8). When a write with auto precharge command WAP₀ or a read command RED₀ (first column access command) is subsequently issued, the address comparison circuits 52A₀ to 52D₀ in the array control circuit 36 acquire the block address Xᵢ and Xⱼ (XᵢR₀ and XⱼR₀) stored in the row address storage circuits 57₀ᵢ and 57₀ⱼ, and generate the hit signal HIT₀. FIG. 30 shows a case where a write with auto precharge command WAP₀ is issued at time t22 along with a column address YA1. The following description deals with such a case.

When the write width auto recharge command WAP₀ is issued at time t22, the column decoder 25 refers to the hit signal HIT₀. This allows the column decoder 25 to perform processing to relieve a defective bit line based on the defective bit line information (the memory contents of a corresponding one of the defective address information storage circuits 53A to 53D) about the memory block corresponding to the row address XA1. Specifically, if the hit signal HIT₀ is at a low level (no coincidence), the column decoder 25 brings the column switch line YSL₀ corresponding to the column address YA1 into a connected state. The row cache register 23₀ corresponding to the column address YA1 is thereby connected to the data control circuit 26 through the I/O line pair IOLP. On the other hand, if the hit signal HIT₀ is at a high level (coincidence), the column decoder 25 activates the column switch line YSL₀ corresponding to the redundant data line pair RDLP₀ instead of the column switch signal YSL₀ corresponding to the column address YA1. The row cache register 23₀ corresponding to the redundant data line pair RDLP₀ is thereby connected to the data control circuit 26 through the I/O line pair IOLP. In addition to such control, the array control circuit 36 performs the control shown in FIGS. 11 and 12. Write data DQ input from the data input/output terminal 16 (FIG. 1) is thereby written to the row cache register 23₀, and further written into the corresponding memory cell MC through the sense amplifier 29.

Next, at time t23, an act command ACT₁ (second act command) is supplied from outside. The processing of the array control circuit 36 here differs from the processing when the act command ACT₀ is supplied in that the transfer signal TC₁ is activated instead of the transfer signal TC₀, and that the block address Xᵢ and Xⱼ included in a row address XA2 supplied along with the act command ACT₁ is stored into the row address storage circuits 57₁ᵢ and 57₁ᵢ instead of the row address storage circuits 57₀ᵢ and 57₀ⱼ. Although not shown in FIG. 29, the array control circuit 36 writes the row address XA2 into the page address storage circuit 50₁, and turns off the page close flag on the flag storage circuit 51₁ (see FIG. 8). Consequently, even if the page designated by the row address XA1 has been maintained open since the issuance of the act command ACT₀, a new act command ACT₁ can be issued to open a page corresponding to a row address XA2 input with the act command ACT₁ in parallel.

If a write with auto precharge command WAP₁ or read command RED₁ (second column access command) is issued, the column decoder 25 refers to the hit signal HIT₁ instead of the hit signal HIT₀. This allows the column decoder 25 to perform processing to relieve a defective bit line based on the defective bit line information (the memory contents of a corresponding one of the defective address information storage circuits 53A to 53D) about the memory block corresponding to the row address XA2. FIG. 30 shows a case where a read command RED₁ is issued at time t24.

As has been described above, according to the semiconductor device 10 of the present embodiment, it is possible to open two pages in parallel and make a column access to each page. This allows faster operations.

If there is only one I/O line pair IOLP, the column accesses to the pages cannot be performed in parallel. The reason is that the pieces of data conflict on the I/O line pair IOLP. If two or more I/O line pairs IOLP are prepared, the column accesses to the pages can be performed in parallel, provided that the memory cells MC to be accessed are connected to respective different I/O line pairs IOLP.

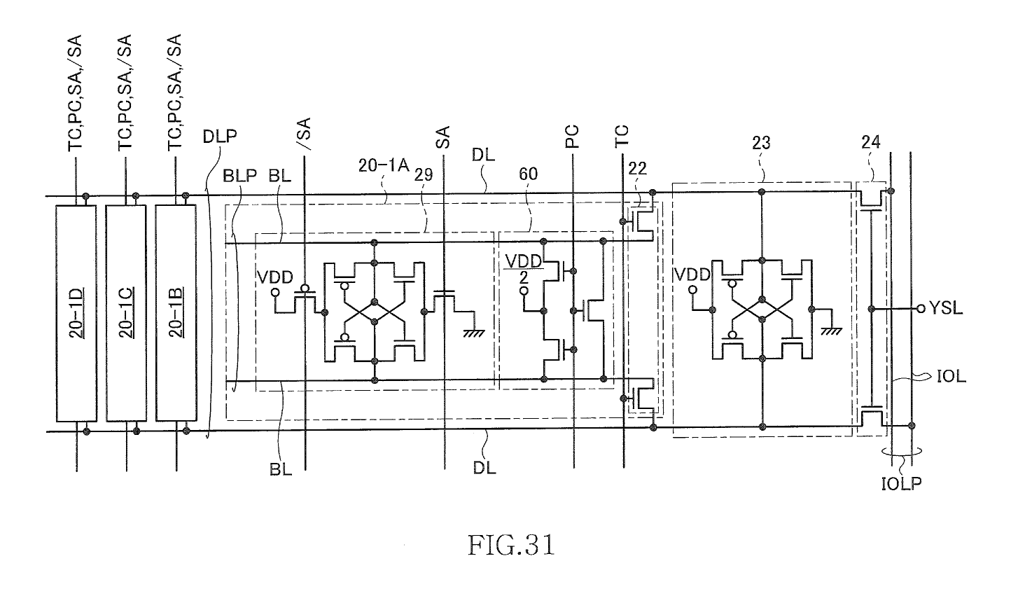

Turing to FIGS. 30 and 31, the semiconductor device 10 according to a fourth embodiment of the present invention is the same as the semiconductor device 10 according to the second embodiment (FIG. 20) except the following points. The semiconductor device 10 according to the present embodiment does include neither the page address storage circuit 50 nor the flag storage circuit 51, and thus a write back command W/B needs to be used. The power supply voltage VDD is directly supplied to either one of the power supply nodes of the two CMOS inverters of the row cache register 23 without a P-channel MOS transistor. The other power supply node is directly grounded without an N-channel MOS transistor. A description will be given below with a focus on the differences from the semiconductor device 10 according to the second embodiment.

In the present embodiment, the commands to be supplied to the command terminals 14 include a write back command W/B. Address signals A0 to Ai input in synchronization with the write back command W/B indicate a row address XA. The address signals A0 to Ai are supplied to the row address buffer 33.

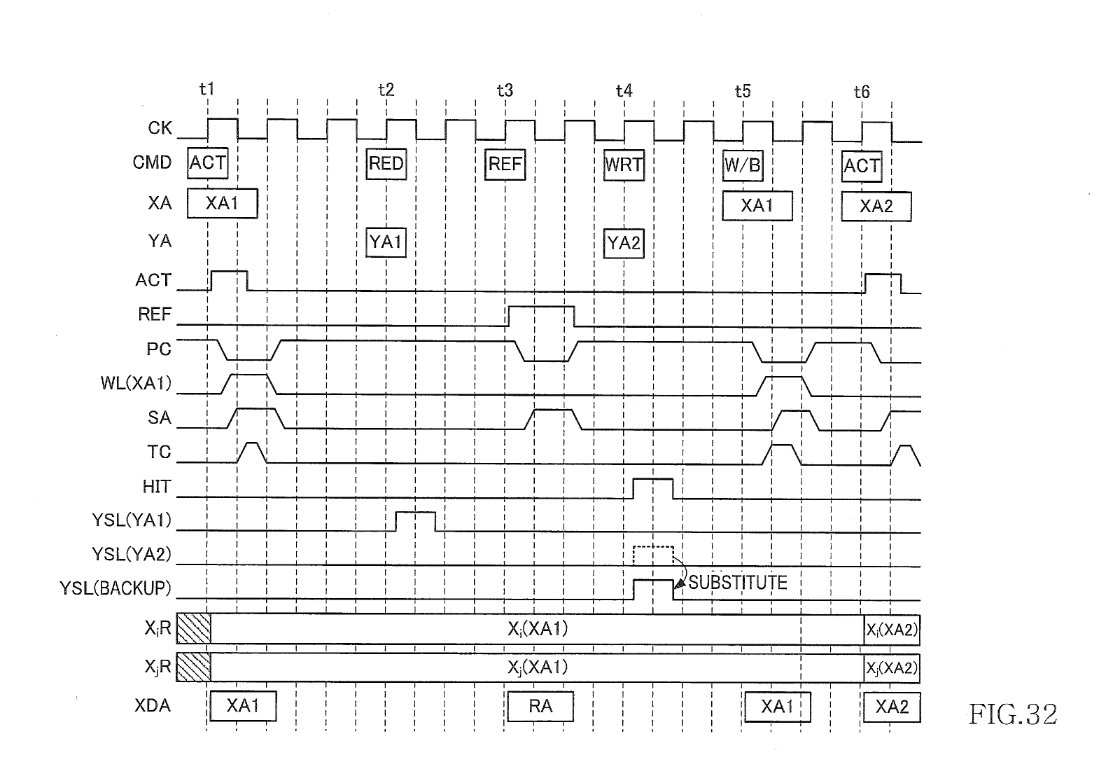

Turning to FIG. 32, the processing up to time t3 is the same as that of the second embodiment shown in FIG. 24. The following description deals only with the processing at time t4 and later.

In the present embodiment, a write command WRT is supplied from outside at time t4. A column address YA2 is further supplied in synchronization with the write command WRT. The chip control circuit (FIG. 19) activates an internal write command WRT. In response, the array control circuit 36 performs the foregoing processing for generating the hit signal HIT on the first address information that includes the supplied column address YA2 and the block address Xᵢ(XA1) and Xⱼ(XA1) stored in the row address storage circuits 57ᵢ and 57ⱼ. The hit signal HIT here is at a high level (coincidence). Receiving the input of the hit signal HIT and the column address YA2, the column decoder 25 activates the column switch line YSL(backup) corresponding to the redundant data line pair RDLP instead of the column switch line YSL(YA2) corresponding to the column address YA2. The row cache register 23 corresponding to the redundant data line pair RDLP is thereby connected to the data control circuit 26 through the I/O line pair IOLP. Subsequently, the memory contents of the row cache register 23 are rewritten with write data DQ input from the data input/output terminal 16 (FIG. 1) by the processing of the data control circuit 26 etc. As a result, the memory contents of the row cache register 23 become inconsistent with the memory contents of the corresponding memory cell MC.

Next, at time t5, a write back command W/B is supplied from outside. A row address XA1 is further supplied in synchronization with the write back command W/B. The chip control circuit 31 (FIG. 19) activates an internal write back command W/B. In response, the array control circuit 36 deactivated the precharge signal PC for a predetermined period. The array control circuit 36 activates the word line WL(XA1) designated by the row address XA1 again, and further activates the transfer signal TC. As a result, weak signals corresponding to the data read from the memory cells MC are overwritten with the memory contents of the row cache registers 23. The array control circuit 36 subsequently activate the sense amplifier signal SA for a predetermined period. The memory contents of the row cache registers 23 are thereby written into the memory cells MC, resolving the inconsistency between the memory contents of the row cache registers 23 and those of the memory cells MC. The transfer signal TC is deactivated after the memory contents of the row cache registers 23 are written to the memory cells MC. The word line WL(XA1) is then deactivated. As shown in FIG. 8, the sense amplifier signal SA is then deactivated, and finally the precharge signal PC is activated.

Subsequently, it becomes possible to input a new act command ACT from outside. When an act command ACT is received at time t6, the memory contents of the address storage circuits 57ᵢ and 57ⱼ are rewritten with a newly input row address XA2. Since the rest of the processing is the same as the foregoing, a detailed description will be omitted.

As has been described above, the semiconductor device 10 according to the present embodiment can also determine defective bit line pairs BLP memory block by memory block. This improves the efficiency for relieving defective bit line pairs BLP as compared to heretofore.

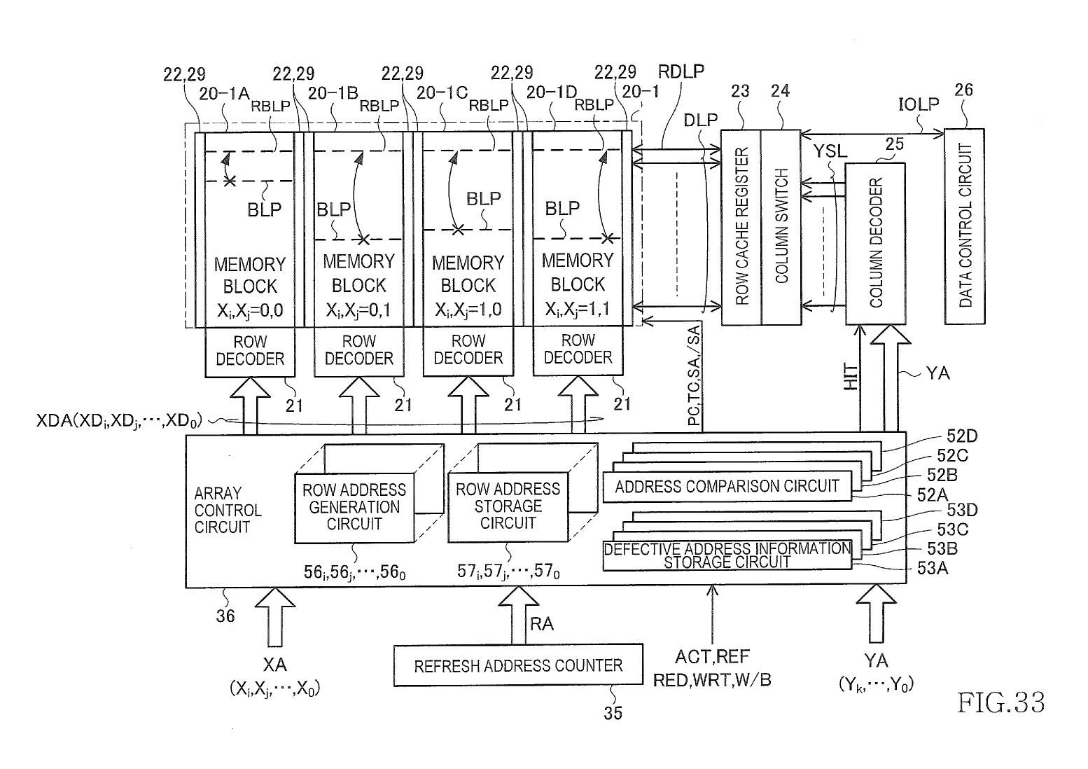

Turning to FIG. 33, the semiconductor device 10 according to the fifth embodiment of the present invention differs from the semiconductor device 10 according to the fourth embodiment in the inclusion of row address storage circuits 57ᵣ, (n=i, j, . . . , 0) for respective bits of the row address XA. The internal configuration of the row address generation circuits 56ₙ (n=i, j, . . . , 0) is accordingly different from that of the fourth embodiment (see FIG. 22A). In other respects, the semiconductor device 10 according to the present embodiment is the same as the semiconductor device 10 according to the fourth embodiment. Similar components will thus be designated by the same reference symbols. A description will be given below with a focus only on the differences.

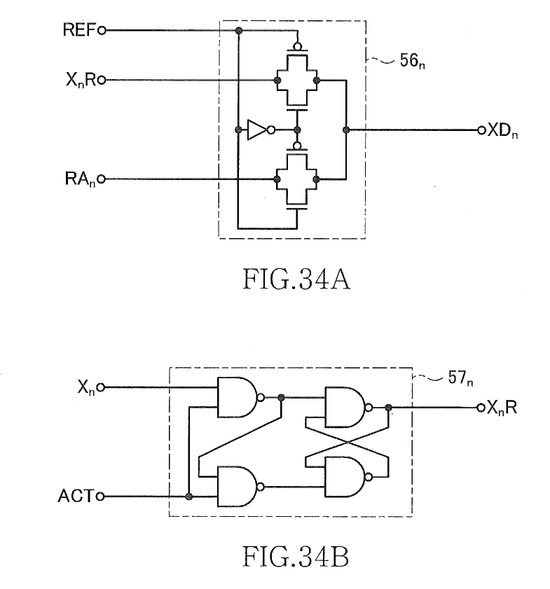

As shown in FIG. 34B, the row address storage circuit 57ₙ is a D-type latch circuit. The row address storage circuit 57ₙ acquires and stores a row address Xₙ when the act command ACT is activated, and retains the acquired row address Xₙ after the act command ACT is deactivated until the next activation. The output of the row address storage circuit 57ₙ is supplied to the row address generation circuit 56ₙ as a row address XₙR. Like the first embodiment, the block address XᵢR and XⱼR, the outputs of the row address storage circuits 57ᵢ and 57ⱼ, is also supplied to the address comparison circuits 52A to 52D.

As shown in FIG. 34A, the row address generation circuit 56ₙ according to the present embodiment differs from the row address generation circuit 56ₙ according to the fourth embodiment in that the row address XₙR is supplied from the row address storage circuit 57ₙ instead of the row address Xₙ that is directly input from the row address buffer 33. In other respects, the row address generation circuit 56ₙ according to the present embodiment is the same as the row address generation circuit 56ₙ according to the fourth embodiment.

With the foregoing configuration employed, the semiconductor device 10 according to the present embodiment need not input a row address when issuing a write back command W/B. A detailed description will be given below.

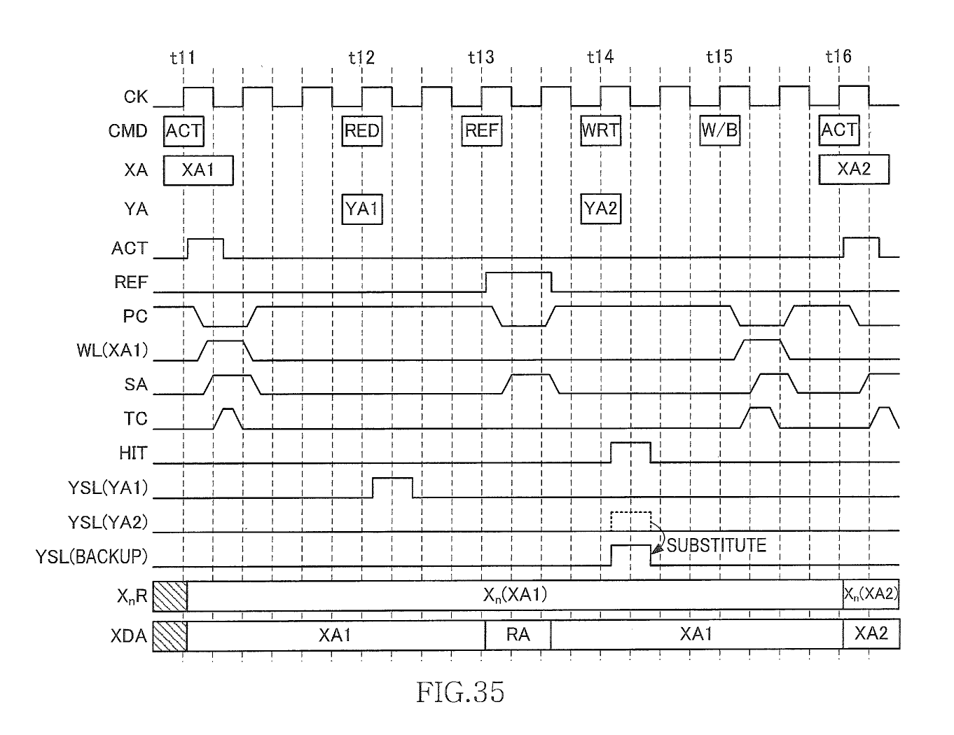

As shown in FIG. 35, in the present embodiment, when an act command ACT and a row address XA1 are supplied from outside, the entire row address XA1 is retained by the row address storage circuits 57ₙ.

After the act command ACT is supplied from outside at time t11, the row address XDA that the array control circuit 36 outputs to the row decoders 21 becomes the same as the row address XA1. Such a state is maintained until an auto refresh command REF is issued at time t13. As can be seen from the configuration of the row address generation circuits 56ₙ shown in FIG. 34A, when the auto refresh command REF is issued at time t13, the row address XDA becomes the same as the refresh address RA. This makes it possible to perform a refresh operation.

When the internal auto refresh command REF is deactivated, the row address XDA becomes the same as the row address XA1 again. Such a state is maintained even when a write back command W/B is issued at time t15. In the present embodiment, the row address XA1 supplied along with the act command ACT is thus retained until the issuance of the write back command W/B. This eliminates the need to input the row address XA1 from outside again when issuing the write back command W/B.

As has been described above, the semiconductor device 10 of the present embodiment can provide a configuration that eliminates the need to input a row address when issuing a write back command W/B.

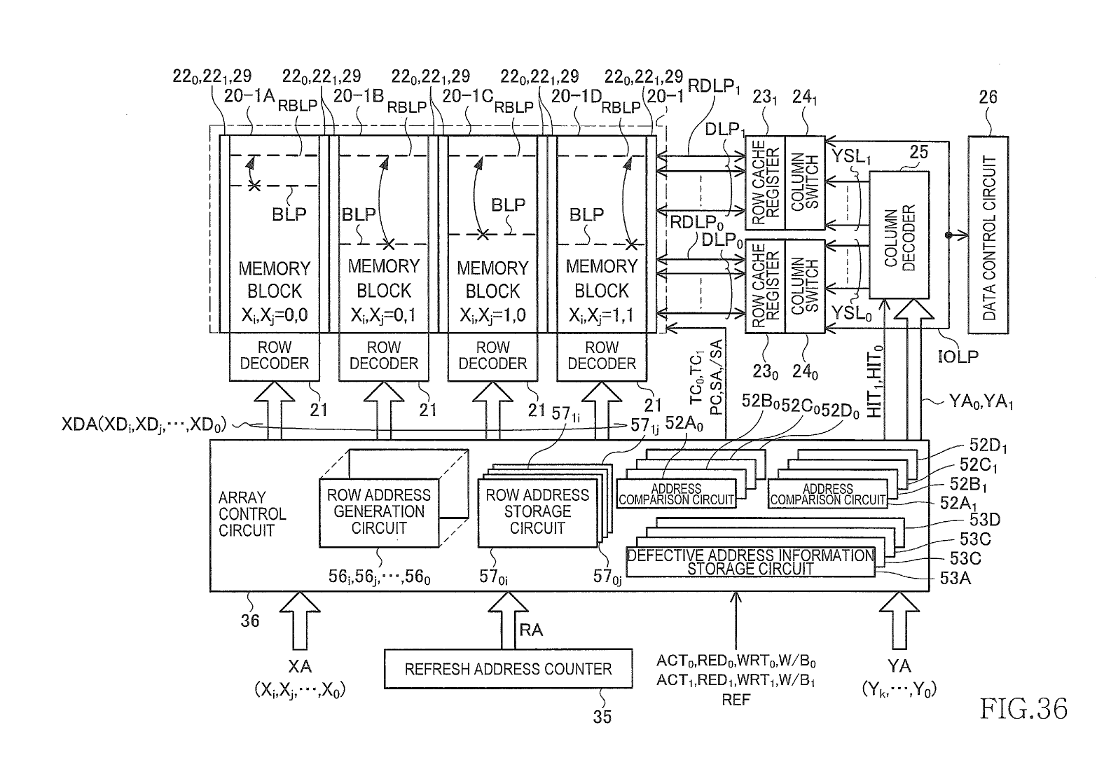

Turning to FIG. 36, the semiconductor device 10 according to the sixth embodiment of the present invention is the same as the semiconductor device 10 according to the third embodiment (FIG. 25) except that none of the page address storage circuits 50₀ and 50₁ and the flag storage circuits 51₀ and 51₁ is included and a write back command W/B needs to be used. A description will be given below with a focus on the differences from the semiconductor device 10 according to the third embodiment.

In the present embodiment, like the fourth embodiment, the commands to be supplied to the command terminals 14 include a write back command W/B. Address signals A0 to Ai input in synchronization with the write back command W/B indicate a row address XA. The address signals A0 to Ai are supplied to the row address buffer 33.

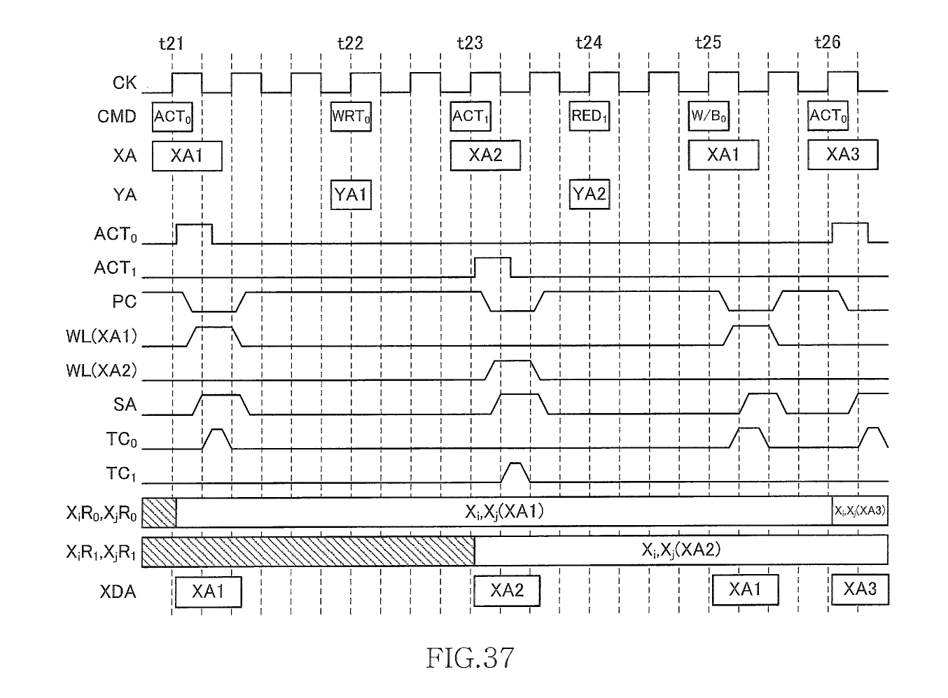

Turning to FIG. 37, the processing at time t21 is the same as that of the third embodiment shown in FIG. 29 except that no control on the page address storage circuit 50₀ or the flag storage circuit 51₀ is included. The following description deals only with the processing at time t22 and later.

When a write command WRT₀ is issued at time t22, the column decoder 25 refers to the hit signal HIT₀. This allows the column decoder 25 to perform the processing for relieving a defective bit line based on the defective bit line information (the memory contents of a corresponding one of the defective address information storage circuits 53A to 53D) about the memory block corresponding to the row address XA1. Specifically, if the hit signal HIT₀ is at a low level (no coincidence), the column decoder 25 brings the column switch line YSL₀ corresponding to the column address YA1 into a connected state. The row cache register 23₀ corresponding to the column address YA1 is thereby connected to the data control circuit 26 through the I/O line pair IOLP. On the other hand, if the hit signal HIT₀ is at a high level (coincidence), the column decoder 25 activates the column switch line YSL₀ corresponding to the redundant data line pair RDLP instead of the column switch line YSL₀ corresponding to the column address YA1. As a result, the row cache register 23₀ corresponding to the redundant data line pair RDLP is connected to the data control circuit 26 through the I/O line pair IOLP.

The processing of the array control circuit 36 when a write back command W/B₀ is issued is the same as that of the fourth embodiment shown in FIG. 32 except that the transfer signal TC₀ is activated instead of the transfer signal TC. Consequently, the memory contents of the row cache registers 23₀ are written into the corresponding memory cells MC through the sense amplifiers 29. In the present example, a write back command W/B₀ is issued at time t25.

The processing of the array control circuit 36 when an act command ACT₁ (second act command) is supplied from outside at time t23 is the same as that of the third embodiment shown in FIG. 29 except that no control on the page address storage circuit 50₀ or the flag storage circuit 51₀ is included. Consequently, in the period between the issuance of the act command ACT₀ and the issuance of the write back command W/B₀, i.e., while the page corresponding to the row address XA1 input with the act command ACT₀ is open, a new act command ACT₁ can be input to open the page corresponding to a row address XA2 input with the act command ACT₁ in parallel.

If a write back command W/B₁ is issued, the array control circuit 36 activates the transfer signal TC₁ instead of the transfer signal TC₀. The memory contents of the row cache registers 23₁ are thereby written into the corresponding memory cells MC through the sense amplifiers 29.

As has been describe above, according to the semiconductor device 10 of the present embodiment, it is possible to open two pages in parallel and make a column access to each page. This allows faster operations.

If there is only one I/O line pair IOLP, the column accesses to the pages cannot be performed in parallel. The reason is that the pieces of data conflict on the I/O line pair IOLP. If two or more I/O line pairs IOLP are prepared, the column accesses to the pages can be performed in parallel, provided that the memory cells MC to be accessed are connected to respective different I/O line pairs IOLP.

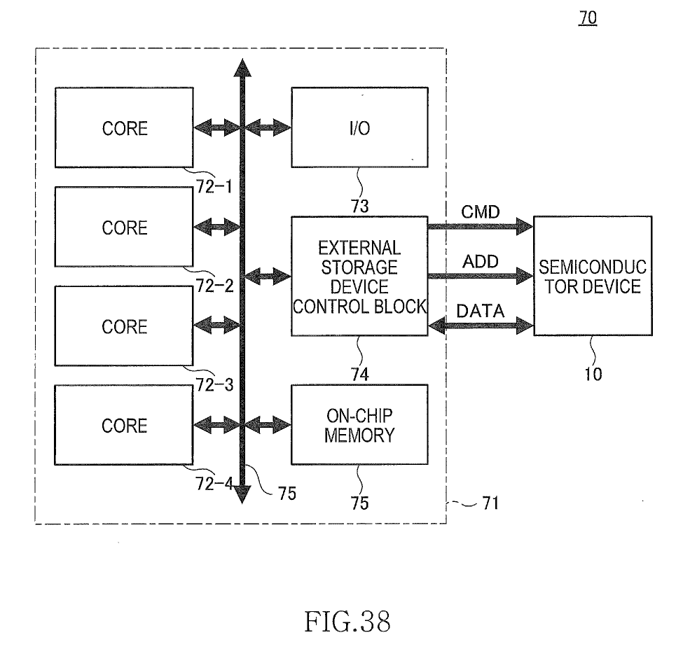

Turning to FIG. 38, the computer 70 includes a semiconductor device 10 and a multicore processor 71. The semiconductor device 10 is one of the semiconductor devices 10 described in the first to sixth embodiments. In the present embodiment, the semiconductor device 10 is incorporated in the computer 70 as a so-called main memory.

The multicore processor 71 includes four cores 72-1 to 72-4, an input/output device (I/O) 73, an external storage device control block 74, an on-chip memory 75, and an internal bus 76. The four cores 72-1 to 72-4 are configure to read and write the semiconductor device 10 independently of each other through the external storage device control block 74.

The cores 72-1 to 72-4 are associated with the banks 20-1 to 20-4 of the semiconductor device 10, respectively. According to the semiconductor device 10, it is possible to ensure compatibility with semiconductor devices using no row cache register, as well as maintain a memory access efficiency equivalent to that of conventional semiconductor devices that employ row cache registers. According to the computer 70 of the present embodiment, the cores 72-1 to 72-4 can read/write the respective banks without opening the same pages again even if an auto refresh operation is performed in a page access period, while using the external storage device control block 74 that is intended for semiconductor devices using no row cache register.

It is apparent that the present invention is not limited to the above embodiments, but may be modified and changed without departing from the scope and spirit of the invention.

For example, while the foregoing embodiments have dealt with a semiconductor device 10 of four bank configuration, the present invention is applicable regardless of the number of banks. The same holds for the number of memory blocks in a memory bank. The present invention is applicable regardless of the number of memory blocks.

The foregoing embodiments have dealt with the cases where the bit lines, data lines, and I/O line are configured as a paired line each (bit line pairs, data line pairs, and an I/O line pair). It will be understood that such lines can be configured as single lines.

What is claimed is:

1. A device comprising:
a memory cell array including a plurality of pages;
a row cache register; and
an array control circuit configured to:
select one of the pages as a selected page to form an electrical path between the selected page and the row cache register in response to a first command with a row address;
cut the electrical path between the selected page and the row cache register; and
form the electrical path again between the selected page and the row cache register in response to a second command without the row address.

2. The device as claimed in claim 1, wherein
the array control circuit includes a page address storage circuit storing the row address, and
the array control circuit obtains the row address from the page address storage circuit in response the second command.

3. The device as claimed in claim 1, wherein
the array control circuit includes a page close flag that is activated when the electrical path between the selected page and the row cache register is cut, and
the array control circuit forms the electrical path again between the selected page and the row cache register in response further to the page close flag being activated.

4. The device as claimed in claim 3, wherein
the array control circuit is further configured to allow to accept the second command without the row address prior to cutting the electrical path between the selected page and the row cache register.

5. The device as claimed in claim 1, further comprising:
an I/O line;
a column switch connected between the I/O line and the row cache register; and
a column decoder bringing the column switch into an ON state after the electrical path is formed between the selected page and the row cache register.

6. The device as claimed in claim 1, wherein the first command is an active command and the second command is a write command.

7. The device as claimed in claim 6, wherein the electrical path between the selected page and the cache register is cut in response to a precharge command.

8. The device as claimed in claim 1, further comprising:
a plurality of bit lines each connected to an associated one of the pages;
a data line connected to the row cache register; and
a plurality of transfer switches each connected between an associated one of the bit lines and the data line,
wherein the electrical path between the selected page and the row cache register is formed by bringing one of the transfer switches into an ON state, and is cut by bringing the transfer switches into an OFF state.

9. A device comprising:
a memory cell array including a plurality of pages;
a row cache register; and
an array control circuit including a page address storage circuit that stores a row address supplied last time thereto, the array control circuit opening one of the pages selected based on the row address stored in the page address storage circuit and connecting the selected page to the row cache register in response to write command when none of the pages is opened.

10. The device as claimed in claim 9, wherein
the array control circuit further includes a page close flag that is activated when none of the pages is opened, and
the array control circuit determines whether none of the pages is opened based on the page close flag.

11. The device as claimed in claim 9, wherein the array control circuit opens and connects another one of the pages to the row cache register when another row address is supplied along with an active command, and subsequently disconnects the pages from the row cache register.

12. The device as claimed in claim 9, wherein
the memory cell array is divided into a plurality of memory blocks,
the pages belong to the respective different memory blocks,
the device further comprises:
a plurality of bit lines each connected to an associated one of the pages;
a data line connected to the row cache register; and
a plurality of transfer switches each connected between an associated one of the bit lines and the data line, and
the array control circuit connects the selected pages to the row cache register by bringing one of the transfer switches corresponding to the selected page designated by the row address obtained from the page address storage circuit into an ON state.

13. A device comprising:
an I/O line;
a plurality of data lines including a first redundant data line and a first defective data line;
a plurality of column switches each connected between an associated one of the data lines and the I/O line;
a plurality of row cache registers each connected to an associated one of the data lines;
a plurality of memory blocks each including a bit line and a plurality of word lines, one of the memory blocks being selected based on a block address which is a part of a row address;
a plurality of transfer switches each connected between an associated one of the bit lines and an associated one of the data lines; and
an array control circuit activating one of the word lines based on the row address and temporarily bringing one of the transfer switches related to the activated word line into an ON state, wherein
the array control circuit includes:
a first defective address information storage circuit storing first address information indicating a combination of a column address related to the first defective data line and the block address of one of the memory blocks related to the first defective data line; and
a row address storage circuit storing at least the block address included in the row address supplied from outside,
the array control circuit obtains second address information in response to a write command, the second address information indicating a combination of a column address supplied from outside along with the write command and the block address stored in the row address storage circuit,
the array control circuit brings one of the column switches based on the column address supplied from outside into an ON state when the second address information does not coincide with the first address information stored in the first defective address information storage circuit,
the array control circuit brings one of the column switches corresponding to the first redundant data line into an ON state when the second address information coincides with the first address information stored in the first defective address information storage circuit, and
the array control circuit activates one of the word lines based on the row address and brings one of the transfer switches related to the activated word line into an ON state in response to the write command.

14. The device as claimed in claim 13, further comprising a refresh address counter generating a refresh address,
wherein the array control circuit, when an auto refresh command is issued from outside, activates one of the word lines based on the refresh address generated by the refresh address counter after the transfer switches are brought into an OFF state.

15. The device as claimed in claim 14, wherein the array control circuit activates one of the word lines based on the row address supplied along with an active command from outside.

16. The device as claimed in claim 15, wherein
the array control circuit includes a row address generation circuit generating the row address, the array control circuit activating one of the word lines based on the row address output from the row address generation circuit,
the row address generation circuit outputs the row address that is supplied from outside along with the active command when the active command is issued from outside, and
the row address generation circuit outputs the refresh address generated by the refresh address counter as the row address when the auto refresh command is issued from outside.

17. The device as claimed in claim 13, wherein the array control circuit further includes an address comparison circuit comparing the first address information with the second address information.

18. The device as claimed in claim 13, wherein
the data lines further include a second redundant data line and a second defective data line,
the array control circuit further includes a second defective address information storage circuit, the second defective address information storage circuit storing third address information indicating a combination of a column address related to the second defective data line and the block address of one of the memory blocks related to the second defective data line,
the array control circuit brings the column switch corresponding to the first redundant data line into an ON state when the second address information coincides with the first address information stored in the first defective address storage circuit,
the array control circuit brings the column switch corresponding to the second redundant data line into an ON state when the second address information coincides with the third address information stored in the second defective address information storage circuit, and
the array control circuit brings the column switch based on the column address supplied from outside into an ON state when the second address information coincides with neither first nor third address information.

19. The device as claimed in claim 1, wherein the second command is a write command and the write command is accompanied with a column address.

20. The device as claimed in claim 19, further comprising:
an I/O line;
at least one normal data line and at least one redundant data line each electrically coupled to the row cache register;
at least one normal column switch connected between the normal data line and the I/O line;
at least one redundant column switch connected between the redundant data line and the I/O line; and
a control circuit turning the normal column switch ON when the column address is not a defective address and the redundant column switch ON when the column address is a defective address.
